(19) United States
(12) Patent Application Publication
(10) Pub. No.: US 2015/0351434 A1
(43) Pub. Date: Dec. 10, 2015

(54) Stuffed Fries

(71) Applicant: Frito-Lay North America, Inc., Plano, TX (US)

(72) Inventors: Robert Fase, JR., Frisco, TX (US); Carl Littrell, Dallas, TX (US); John Mampra Mathew, Plano, TX (US); Richard Metivier, Highland Village, TX (US); Sevugan Palaniappan, Plano, TX (US); Joshua Scott Rivner, McKinney, TX (US)

(21) Appl. No.: 14/732,039

(22) Filed: Jun. 5, 2015

Related U.S. Application Data
(60) Provisional application No. 62/170,877, filed on Jun. 4, 2015.
(60) Provisional application No. 62/009,751, filed on Jun. 9, 2014.

(51) Int. Cl. A23L 1/217; A23P 1/12; A23L 1/48; A23L 1/39; A23L 1/00; A23L 1/01

(52) U.S. Cl. CPC A23L 1/2175; A23L 1/0079; A23L 1/01; A23L 1/483; A23L 1/39; A23P 1/125; A23V 2002/00

(57) ABSTRACT

A composition and method for an improved stuffed fry or other cooked food product. Stuffed fries can be made, for example, by coextruding a substrate and filling in a desired ratio to form an extrudate, then cutting, crimping, par frying, freezing, and final frying the extrudate. One composition for stuffed fries comprises a fried substrate that is made from a dough with crimped ends. One composition comprises potatoes, corn syrup, or water in specific weight percentages. One composition for the filling of the stuffed fries is a low moisture filling. One composition comprises at least one gum to reduce free water in the filling and/or substrate by binding to the water in the filling and/or substrate.

### CROSS-REFERENCE TO RELATED APPLICATIONS

This application is a nonprovisional of, and claims priority to, U.S. Provisional Patent Application No. 62/170,877, entitled “Stuffed Fries,” filed Jun. 4, 2015 and U.S. Provisional Patent Application No. 62/009,751, entitled “Stuffed Fries,” filed Jun. 9, 2014, which are all hereby incorporated by reference in their entirety as examples.

### BACKGROUND OF THE INVENTION

1. Technical Field

The present invention relates to a composition and process for making stuffed fries or other coextruded products (e.g., cold coextruded products). For example, the invention relates to a process for coextruding a substrate (e.g. dough) with a filling, cutting the extrudate, crimping the substrate to seal in the filling, battering and/or breading the substrate, par frying (i.e., partially frying) the extrudate, freezing the extrudate, and final frying the extrudate. Although, other processes for cooking can also be used.

2. Description of Related Art

Some consumers desire foods with a combination of organoleptic properties, for example, a combination of different tastes and textures. One way to achieve a desirable combination is the use of a filling inside a dough, for example, a smooth, moist filling inside a crispy or flaky dough. Given the desirability of stuffed or filled products in general, others have made or attempted to make stuffed products such as filled pretzels or stuffed potato tots. However, no one has produced a consumer-acceptable filled French fry-like product.

### SUMMARY OF THE INVENTION

The present invention provides a composition and method for making stuffed fries.

In a first aspect the invention provides a food product comprising a coextruded substrate and filling in a substrate to filling mass ratio of about 90:10 to about 50:50. For example, in one embodiment the substrate is crimped to seal the filling inside the substrate and then fried. In some embodiments, the substrate comprises a vegetable, meat, legume, or starch; about 1.0 to about 6.0 wt % corn syrup on a dry-ingredient-weight basis; and about 30 to about 50 wt % water on a total-substrate-weight basis. In some embodiments the filling comprises a moisture content of less than 60 wt % of the total filling weight.

In a second aspect the invention provides a method for making a food product. For example, one embodiment of the method comprises the steps of coextruding a substrate and a filling to form an extrudate; and cutting, crimping, cooking the extrudate in a first cooking step, freezing the extrudate, and cooking the extrudate in a second cooking step. In one embodiment, the crimping step comprises substantially completely sealing the filling inside the substrate to protect the filling during a first and second cooking step. In some embodiments the first cooking step comprises par frying and the second cooking step comprises final frying.

In a third aspect, the invention provides a cooked food product formed by cooking an extrudate. The extrudate comprises a coextruded substrate and filling. The substrate comprises: at least one component selected from the group consisting of a vegetable, meat, legume, and starch; and about 30 to about 50 wt % water on a total-substrate-weight basis. The filling comprises: about 40 to about 70 wt % water; and at least one gum. A mass ratio of the substrate to the filling is about 90:10 to about 50:50.

In a fourth aspect, the invention provides a method for making a food product. The method comprises the steps of coextruding a substrate and a filling to form an extrudate, cutting the extrudate, and cooking the extrudate a first time. The substrate comprises: at least one component selected from the group consisting of a vegetable, meat, legume, and starch; and about 30 to about 50 wt % water on a total-substrate-weight basis. The filling comprises: about 40 to about 70 wt % water; and at least one gum. A mass ratio of the substrate to the filling is about 90:10 to about 50:50.

The inventors have discovered a new and inventive composition and method for making stuffed fries. In one embodiment, the invention solves or mitigates the problem of applying messy dipping sauces to a substrate (e.g., French fries) under conditions that can exacerbate the potential for making a mess, for example, French fries acquired from a drive-thru window. One embodiment also provides a desirable ratio of sauce to substrate.

In one embodiment, the invention comprises a low moisture filling in a substrate (e.g. dough). For example, when the filling is cooked (e.g., par-fried and then final fried after being frozen or refrigerated) the filling does not produce too much steam, cause the dough to explode, cause the dough to expand too much even if it doesn't explode, cause the dough to become soggy, or cause other textural problems in the dough.

In one embodiment the dough is sufficiently moist that the crimper used to seal the dough provides a good seal. In addition, the dough has an appropriate composition to provide the dough with properties (e.g., sufficient strength) to contain the filling (e.g., during cooking) Such an embodiment can help avoid problems that can occur during cooking For example, the characteristics of the embodiment help prevent the filling from exploding out of the dough, help prevent the dough from acquiring holes, help prevent the filling from seeping out of the dough, and help prevent frying oil from seeping inside the dough. Furthermore, such an embodiment can help prevent damage to the frying oil quality and help prevent oil from seeping into the embodiment, which can both negatively impacting the organoleptic properties of the product. For example, in one embodiment, the crimp is further enhanced by the addition of corn syrup (e.g., high fructose corn syrup).

In one embodiment, the dough and filling possess certain required physical properties for extrudability and also meet consumer expectations for desired organoleptic properties, for example, color, texture and taste. In one embodiment, the dough possesses a composition that provides extrudability and also provides desired organoleptic properties when cooked. For example, the dough is thin enough (e.g., as a result of sufficient water content) that the dough provides a sufficient flow rate through an extruder. However, the dough also has a sufficient thickness to provide a desired flow resistance and to build an appropriate amount of back pressure during extrusion given the equipment (e.g., pump, nozzles, pipes, orifices, dies, etc.) used. One embodiment of the dough also permits sufficient stretching or expansion. As another example, when one embodiment is fried, the dough composition develops a desirable brown color quickly enough to avoid cooking or overcooking the filling before the browning occurs. Another embodiment comprises a dough formulation to provide desired dough thickness and a desired flavor (e.g., a desired potato flavor). As another example, one embodiment has an appropriate composition for the filling and/or dough so that the filling does not blow out of the embodiment during reheat, so that the filling is adequately protected during reheating, and so that the filling is stable at frying temperatures. Another embodiment is a stuffed fry comprising a dough and a filling with compositions that meet consumer expectations when cooked (e.g., providing desired flavor and mouthfeel), while simultaneously exhibiting sufficient extrudability (e.g., appropriate thickness).

In one embodiment the invention provides an improved composition and method for making stuffed fries on a commercial scale. One embodiment comprises a filling that does not escape from the dough to an undesirable degree during cooking. For example, in one embodiment, the filling has limited moisture content. As another example, one embodiment has a filling that is thick and/or viscous, which can help prevent loss (e.g. a blow out) of the filling through the substrate (e.g. dough, or shell) during heating and/or re-heating. One embodiment comprises a dough that adequately contains the filling, is not too soggy, too oily, or too dry and meets consumer expectations for texture, such as crispiness, flakiness, crunchiness, brownness, or other characteristics. One embodiment comprises a dough and filling that satisfy consumer expectations with respect to organoleptic properties while simultaneously satisfying requirements for processing (e.g., flowability, extrudability, susceptibility to crimping, susceptibility to browning, ability to stretch, ability to expand, etc.).

Although the invention is described herein in terms of stuffed fries, the invention also encompasses various other types of filled or stuffed substrates. For example, rather than comprising a potato dough substrate the invention can comprise substrates including but not limited to dough comprising corn, chickpeas, hummus, granola, oats, grain, refined grains, whole grains, rice, sweet potatoes, meat or some combination thereof. For example, one embodiment can be a filled chicken strip. As another example, while the invention is described herein as comprising potato flakes or granules, some embodiments comprise potato shreds. Additionally, while the invention has been described in terms of certain types of fillings, for example, ketchup, cheese, or sour cream, the invention can also comprise other materials, for example dairy-based, meat-based, fruit-based, legume-based, or vegetable-based materials. The invention can also comprise fillings with filling inclusions that comprise dairy-based, fruit-based, legume-based, or vegetable-based material. In some embodiments the filling can include, but is not limited to, fillings comprising and/or filling inclusions comprising, corn, chickpeas, hummus, chicken meat, tomatoes, salsa, ranch, yogurt, sauces, beans, chocolate, fruit or some combination thereof. Furthermore, while one embodiment uses a tube-shaped substrate, other embodiments can be made in a plurality of sizes and shapes, for example, a rectangular-prism, taquito, burrito, pouch, pocket, tube, churro, or triangular-prism.

Other aspects, embodiments and features of the invention will become apparent from the following detailed description of the invention when considered in conjunction with the accompanying drawings. The accompanying figures are schematic and are not intended to be drawn to scale. In the figures, each identical or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flow chart depicting a method that is one embodiment of the invention.

FIG. 1A is another flow chart showing steps, materials, process equipment and conditions for a method that is one embodiment of the invention.

FIG. 2 is a schematic illustration of one embodiment of extrudate according to the invention that is generally tube-shaped and has crimped ends.

FIG. 2A is an illustrative example of one embodiment of extrudate according to the invention that is generally tube-shaped and has crimped ends.

FIG. 2B is an illustrative example showing a plurality of embodiments of extrudate according to the invention, wherein the extrudate is generally tube-shaped and has crimped ends.

FIG. 3 is a schematic illustration of a section of one embodiment of the invention depicting extrudate that comprises a substrate and a filling.

FIG. 3A is an illustrative example showing a plurality of embodiments of extrudate before it has been crimped according to the invention.

FIG. 4 is a schematic illustration of one embodiment of an apparatus comprising equipment for making crimped extrudate.

FIG. 4A is a schematic illustration depicting a perspective view of one embodiment of a die for coextruding a substrate and a filling.

FIG. 4B is a schematic illustration depicting a top view of the die of FIG. 4A for coextruding a substrate and a filling.

FIG. 4C is a schematic illustration depicting a side view of the die of FIG. 4A for coextruding a substrate and a filling.

FIG. 5 is a schematic illustration depicting a perspective view of embodiments of nozzles for coextruding a substrate and a filling.

FIG. 5A is a schematic illustration depicting a perspective view of embodiments of nozzles with equivalent circular diameters equal to those of the nozzles shown in FIG. 5.

FIG. 6 is a schematic illustration depicting a perspective view of an extrudate comprising a substrate and a filling.

FIG. 6A is a schematic illustration depicting a perspective view of an extrudate with equivalent circular diameters equal to those of the substrate and filling shown in FIG. 6.

FIG. 6B is a schematic illustration depicting a perspective view of extrudate comprising a filling with a cross-sectional area that is less than the area bounded by an inner perimeter of a cross-section of the substrate.

FIG. 7 is a schematic illustration depicting a perspective view of one embodiment of a die comprising a substrate nozzle having an inner perimeter with convex edges.

FIG. 8 is a schematic illustration depicting a nozzle for a filling comprising inclusions.

FIG. 9 is a flow chart depicting a method that is one embodiment of the invention.

### DETAILED DESCRIPTION OF THE DRAWINGS

Before the inventors of the present invention, no one had produced a consumer-acceptable filled French fry-like product that could be coextruded. Attempts to make a stuffed fry have run into several problems with respect to processing, and organoleptic properties (e.g., texture, taste, and color) that occur as a result of combining materials with different properties in single food product.

In some products, when the filling is cooked (e.g., frying) it can produce too much steam and result in exploding dough, dough that expands too much even if it doesn't explode, soggy dough, or other dough-related textural problems.

In other products, the crimper that is used to seal the dough may fail to provide a good seal. In addition, the dough can lack properties (e.g., sufficient strength) to contain the filling (e.g., during cooking). If the dough is not properly sealed or does not possess adequate properties for containing the filling, problems can occur during cooking. For example, the filling can explode out of the dough, the dough can acquire holes, the filling can seep out of the dough, and frying oil can seep inside the dough. Furthermore, any filling that seeps out of the dough can damage frying oil quality and oil that seeps into the dough can negatively impact the organoleptic properties of the product. In order overcome these problems, it would be desirable if a stuffed fry provided a better seal for the filling inside the dough when the dough is crimped.

Also, the dough and filling may not be extrudable if they don't possess certain required physical properties, but they may not meet consumer expectations if they don't have desired organoleptic properties, for example, color, texture and taste. As an example of one problem that can occur, the coextrusion process can require a certain composition in the dough and filling to provide necessary extrudability. For example, if the dough is too thick, it can fail to provide a sufficient flow rate through the extruder. On the other hand, the dough needs to be thick enough to provide sufficient flow resistance and to build an appropriate amount of back pressure during extrusion given the equipment (e.g., pump, nozzles, pipes, orifices, dies, etc.) used. The dough also needs to permit sufficient stretching or expansion. However, the compositions of the product that exhibit desired properties for extrudability can be problematic during cooking or fail to provide desired organoleptic properties. For example, when the product is fried, the dough composition can fail to develop a desirable brown color (e.g., golden brown french fry color) quickly enough to avoid cooking or overcooking the filling. As another example, a dough formulation with the desired thickness can fail to provide a desired flavor (e.g., a desired potato flavor). As another example, if an embodiment does not have an appropriate composition for the filling and/or dough, the filling can blow out of the embodiment during reheat, the filling may not be adequately protected during reheating, and the filling may not be stable at frying temperatures. Accordingly, in one embodiment, the present inventions is advantageous in that it provides a stuffed fry comprising a dough and filling with compositions that meet consumer expectations while simultaneously exhibiting sufficient extrudability.

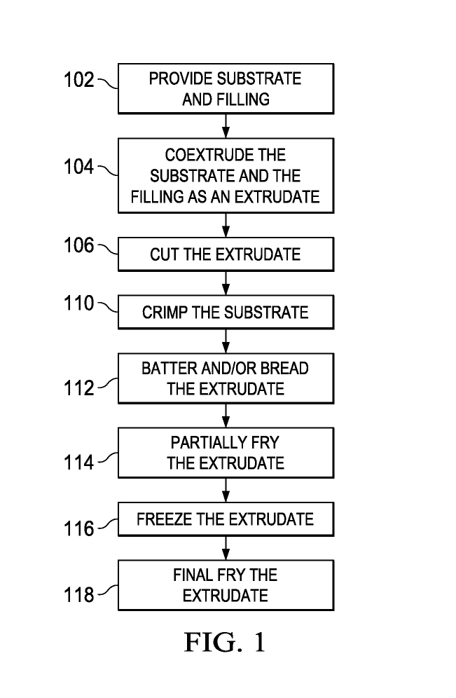

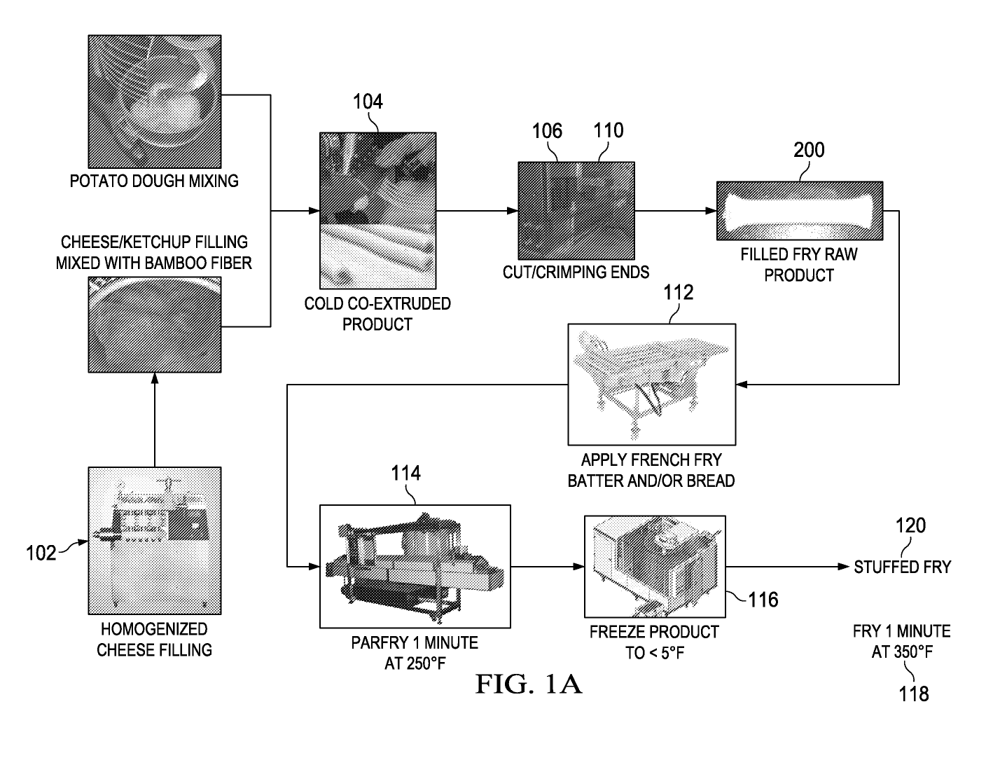

One embodiment of the invention will now be described with reference to FIG. 1. First, in a making step 102, a substrate and a filling (e.g., a savory filling) are provided. Second, in a coextruding step 104, the substrate and the filling are coextruded to form an extrudate. Third, in a cutting step 106, the extrudate is cut to form a desired length of extrudate. Fourth, in a crimping step 110, the substrate is crimped using a crimper to form a crimped substrate. The crimping step seals the substrate so that the filling is substantially (or completely) contained by the substrate. In one embodiment, crimping and cutting occur simultaneously, although in other embodiments they do not occur simultaneously. Fifth, in a battering and/or breading step 112, the extrudate is optionally breaded, battered, or both breaded and battered, for example, using crumbs, batter, powder, flour, or some other material with a relatively small particle size and capable of sticking or binding to the substrate. Sixth, in a par frying step 114, the extrudate is partially fried. For example, the substrate (e.g., dough) is partially fried while the filling is not substantially heated or cooked. Par frying the substrate can be used to impart a desired texture (e.g., crispiness) to the substrate. Although, in some embodiments the extrudate is cooked in a first cooking step using another process, for example, baking. Seventh, in a freezing step 116, the extrudate is frozen. This step can help preserve the extrudate. Although, this embodiment has been described using a freezing step, other embodiments can use different cooling steps, for example, refrigeration. Eighth, in a final frying step 118, the extrudate is final fried. In some embodiments, after an extrudate is final fried it is ready to be consumed. In some embodiments, the extrudate is cooked in a second cooking step using another process, for example, baking

During the par frying step 114 and final frying step 118, when the extrudate is submerged in oil, the substrate (e.g. dough) protects the filling (e.g. ketchup, cheese, or sour cream). If the dough does not have appropriate properties (e.g., being thick enough, being well-crimped, being solid, having an adequate moisture content), if the filling does not have appropriate properties (e.g., moisture content, thickness, viscosity), or if the parameters (e.g., temperature, pressure, time) used to cook the extrudate are inappropriate, various problems can occur. For example, the filling can be cooked or heated to an undesirable degree. The filling can also seep out of the extrudate or explode, or oil can seep into the substrate.

Although this embodiment has been described in terms of a par frying step 114, and a final frying step 118, in other embodiments different cooking or heating processes can be used, for example, baking, toasting, microwaving, frying, or some combination thereof.

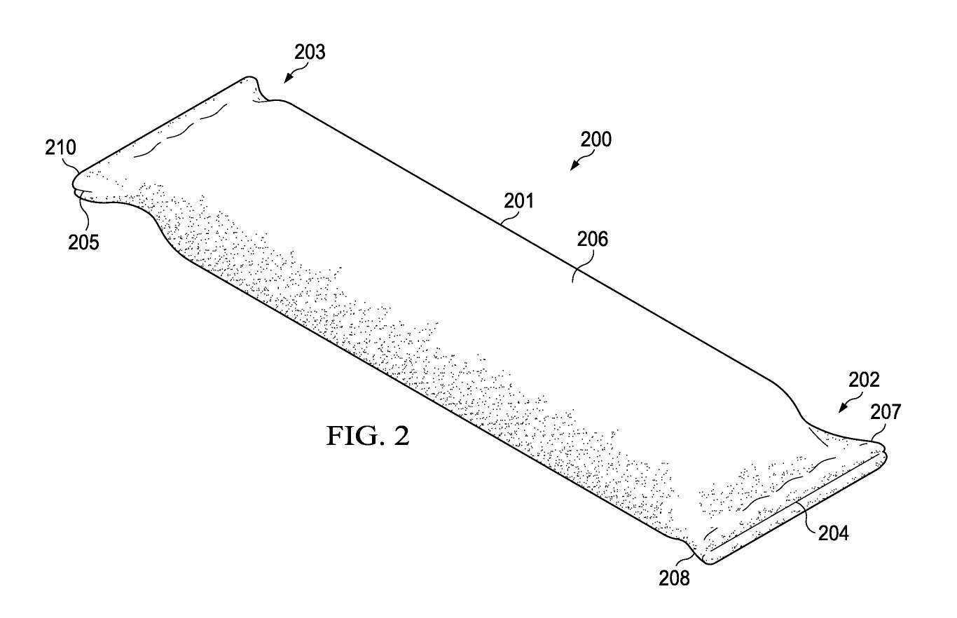

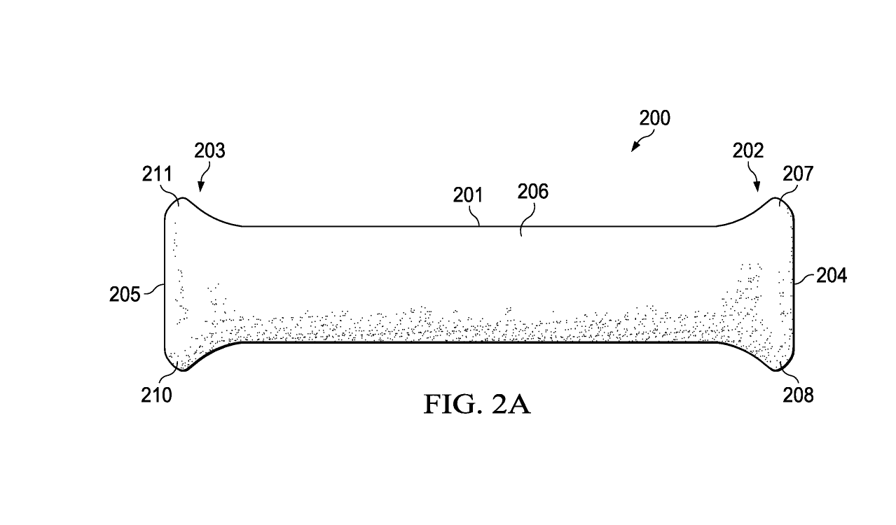

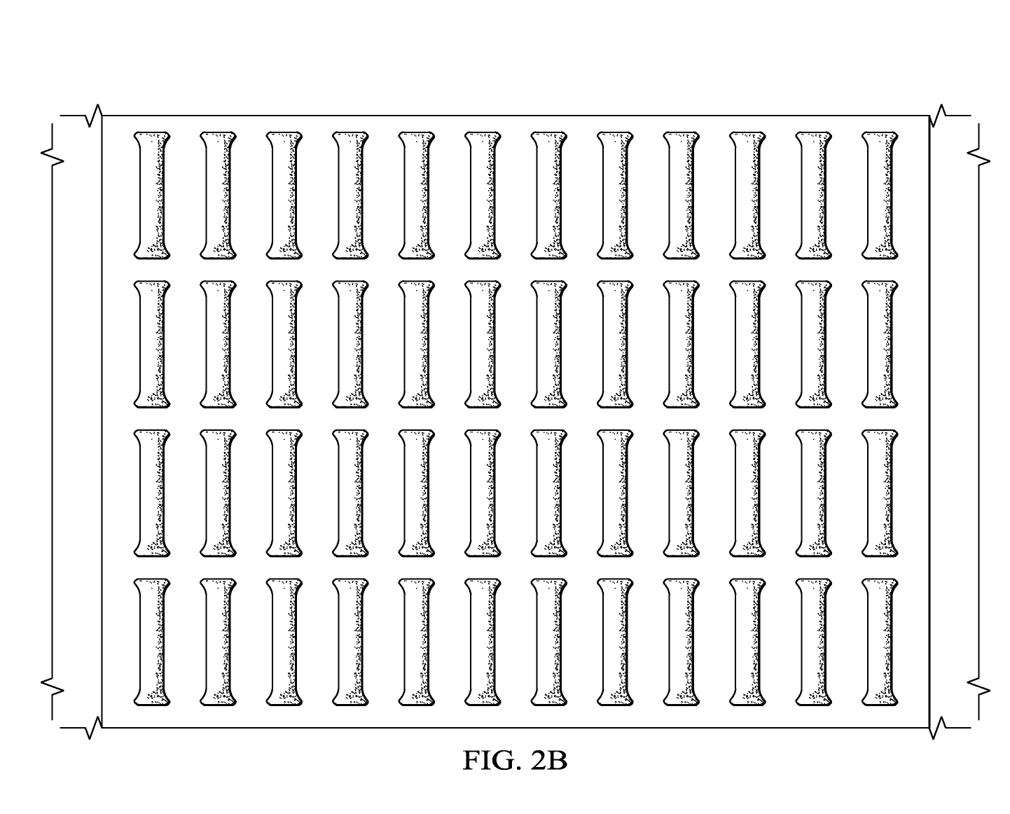

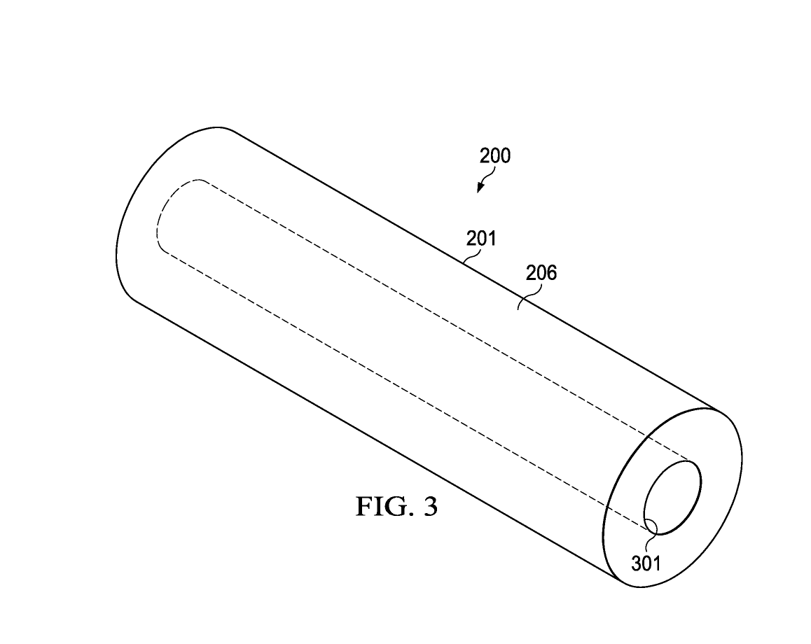

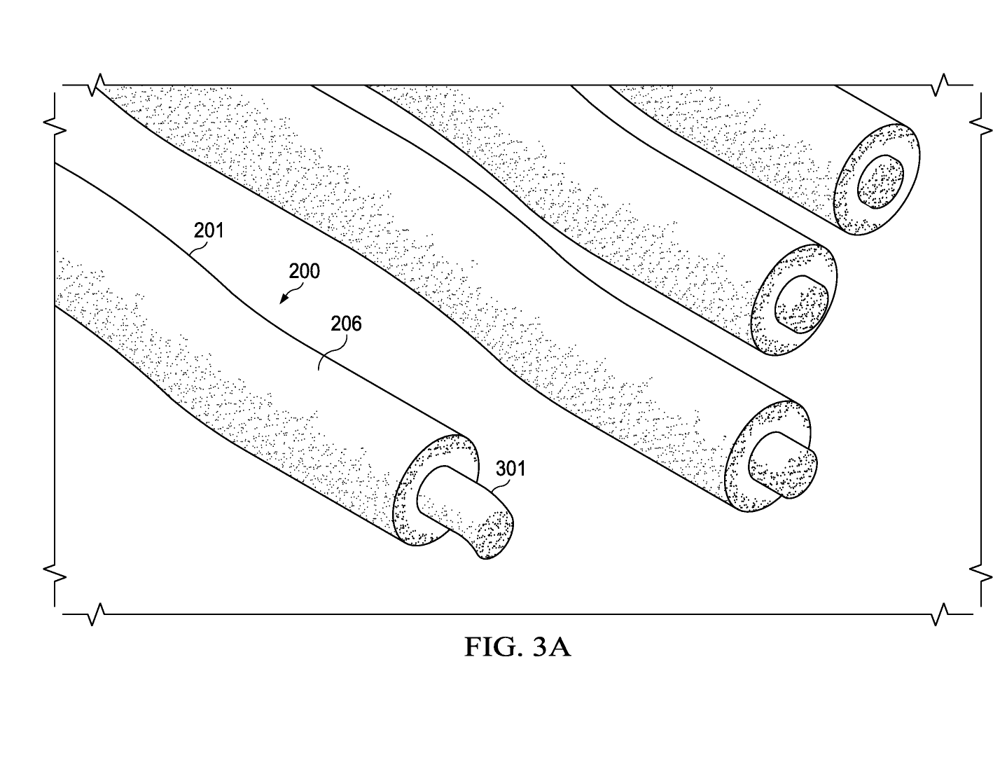

One embodiment of the invention will now be described with reference to FIG. 2. As shown in FIGS. 2 and 3, extrudate 200 comprises a coextruded substrate (e.g., shell) 201 and filling 301. The extrudate 200 comprises a first end 202 and a second end 203. At the first end 202, the substrate 201 comprises a first crimp 204. Accordingly, the first end 202 is a crimped end. At the second in 203 of the extrudate 200, the substrate 201 comprises a second crimp 205. Accordingly, the second and 203 is a crimped end.

FIG. 1A is flow chart showing steps, materials, process equipment and conditions for a method that is one illustrative embodiment of the invention. First, in a making step 102, a substrate and a filling are separately made. As shown in FIG. 1A, the substrate can be made by mixing ingredients for a potato-based dough. The filling can be a cheese or ketchup filling. If, for example, the filing is a cheese filling it can be homogenized. In some embodiments, the cheese or ketchup filling is mixed with bamboo fiber to enhance extrudability. Second, in a coextruding step 104, the substrate and the filling are coextruded to form an extrudate. In the example shown in FIG. 1A, the coextruding uses a cold coextrusion process. The term cold-extrusion indicates that no heat is directly added during the extrusion process, although heat can be generated as a result of friction. Third, in a cutting step 106 and crimping step 110, the extrudate is cut to form a desired length of extrudate and the substrate is crimped using a crimper to form a crimped extrudate. The crimping step seals the substrate so that the filling is substantially completely contained by the substrate. Fifth, in a battering and/or breading step 112, the extrudate is battered by applying French fry batter. In some embodiments, the extrudate is optionally breaded. In some embodiments, the extrudate is battered and then breaded. Sixth, in a par frying step 114, the extrudate is partially fried for about 1 minute at 250° F. Seventh, in a freezing step 116, the extrudate is frozen to less than 5° F. Although in some embodiments the extrudate is frozen to another temperature, for example, less than 10° F. Eighth, in a final frying step 118, the extrudate is final fried for about 1 minute at 350° F. to provide a stuffed fry 120. In one embodiment, a baking step is used as an alternative to the final frying step 118, for example, baking at about 425° F. for about 15-20 minutes. Although, the cooking times can vary depending upon the oven used. In another embodiment, the baking temperature can vary from about 400° F. to 450° F. with the cooking time varying accordingly, for example, from about 20 minutes for 455° F. to about 15 minutes for 400° F. In another embodiment, the baking temperature can vary from about 400° F. to 450° F. and the cooking time can varying from about 15-20 minutes. If the extrudate is cooked for too long, at too high of a temperature, or if other process conditions or the compositions for the substrate and filling are not appropriate for cooked, filled substrates as described herein, then a blow-out may occur and the filling may seep out of the extrudate. However, in one embodiment, a composition and method according to the invention, ruptured extrudate is avoided. Although certain conditions are described, for example, for par frying, freezing, baking, or final frying the extrudate, these conditions are illustrative, rather than exclusive conditions.

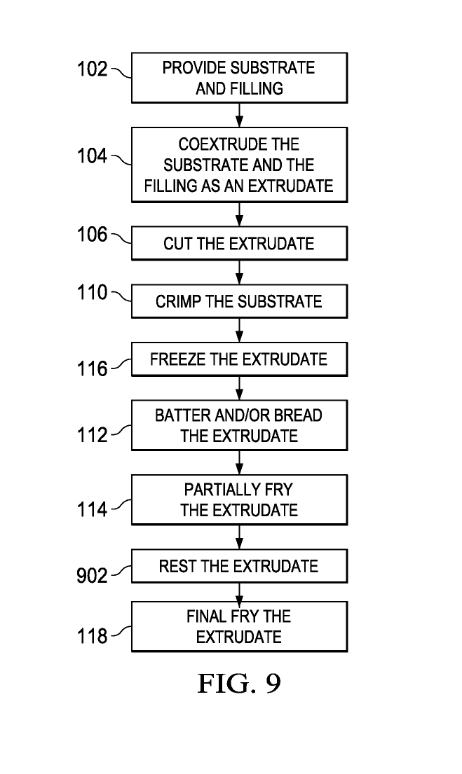

One embodiment will now be described with reference to FIG. 1 and FIG. 9. In one embodiment, a method further comprises the steps: freezing 116 the extrudate 200, battering and/or breading 112 the extrudate 200 with a starch and/or starch solution, resting the extrudate 200, and cooking the extrudate 200. In one embodiment, the steps are ordered as follows:

(1) coextruding 104 the substrate 201 and the filling 301 to form an extrudate 200;

(2) cutting 106 the extrudate 200;

(3) crimping 110 the extrudate 200;

(4) freezing 116 the extrudate 200;

(5) battering and/or breading 112 the extrudate 200 with the starch and/or starch solution;

(6) cooking the extrudate 200 the first time (e.g., par frying 114, for example, at 350° F. for 45 seconds);

(7) resting 902 the extrudate 200 (e.g., cooling at room temperature for 3 minutes);

(8) cooking the extrudate 200 the second time (e.g., final frying 118, for example, at 350° F. for 30 seconds).

In one embodiment, the steps are ordered as follows:

(1) coextruding 104 the substrate 201 and the filling 301 to form an extrudate 200;

(2) cutting 106 the extrudate 200;

(3) crimping 110 the extrudate 200;

(4) battering and/or breading 112 the extrudate 200 with the starch and/or starch solution;

(5) cooking the extrudate 200 the first time (e.g., par frying 114, for example, at 350° F. for 45 seconds);

(6) freezing the extrudate 200;

(7) cooking the extrudate 200 the second time (e.g., final frying 118, for example, at 350° F. for 30 seconds).

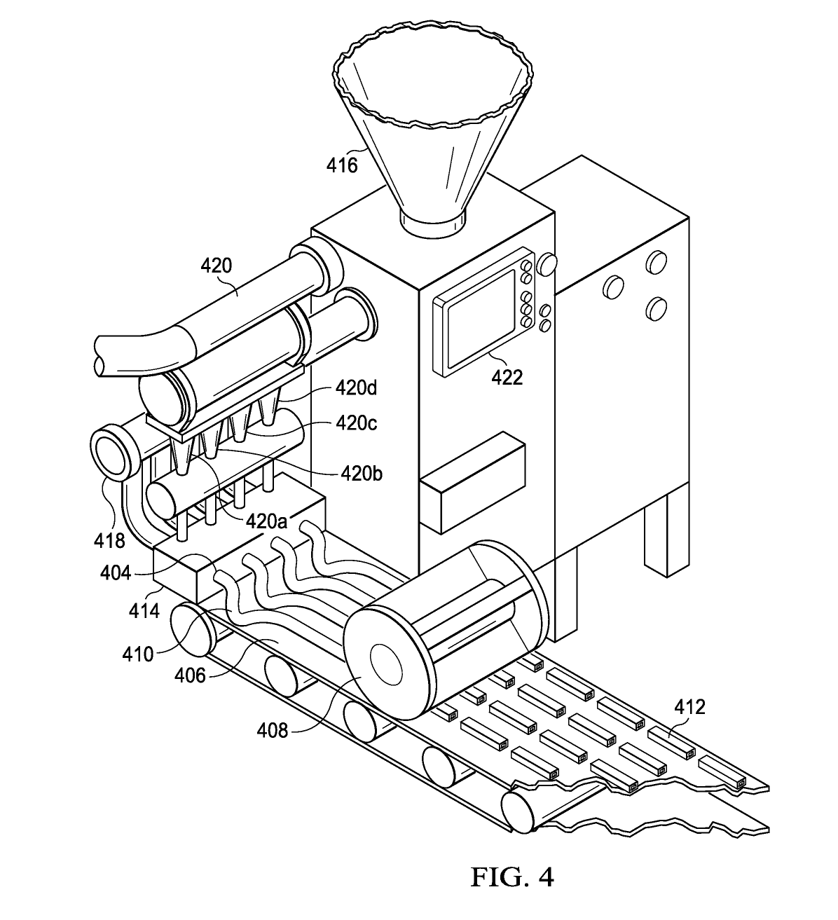

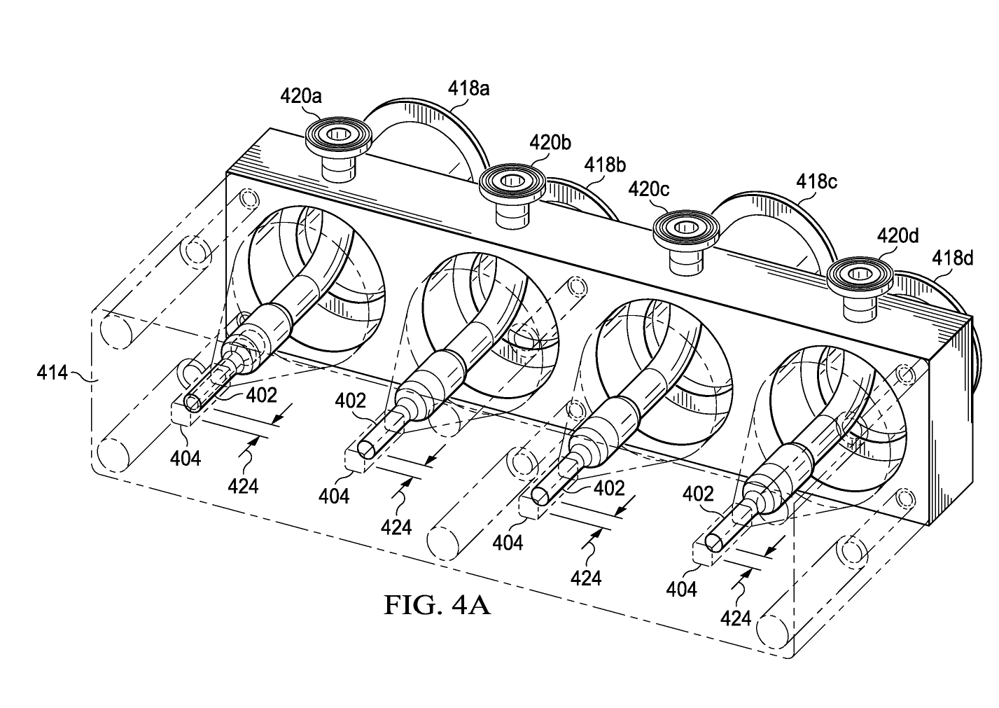

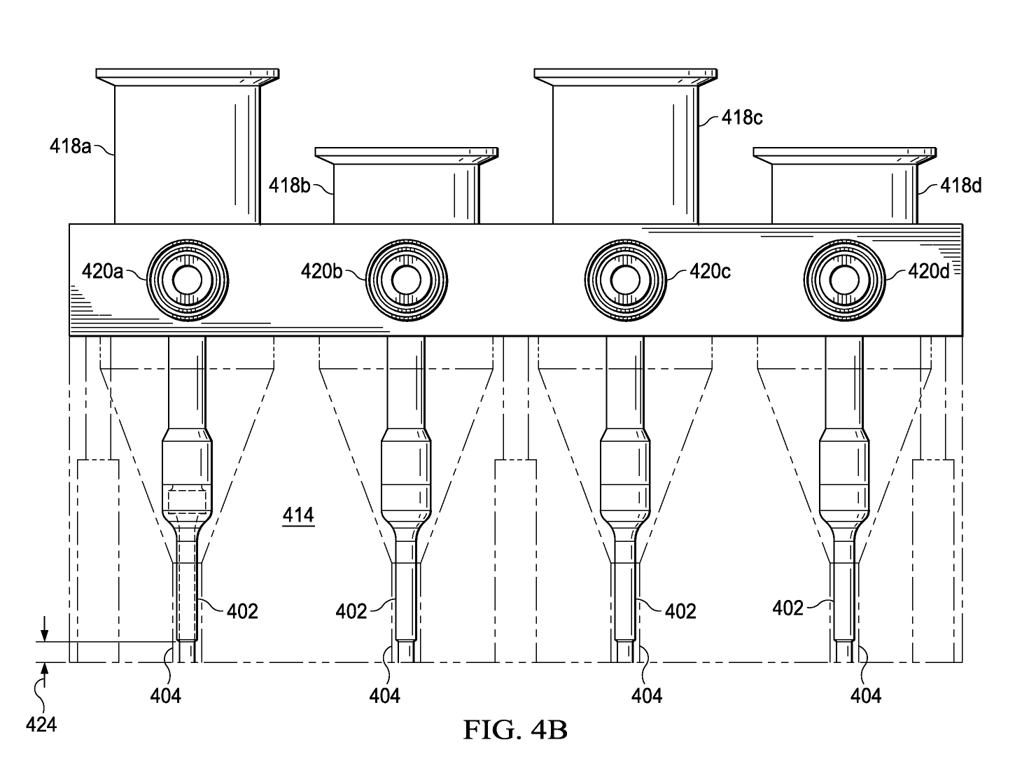

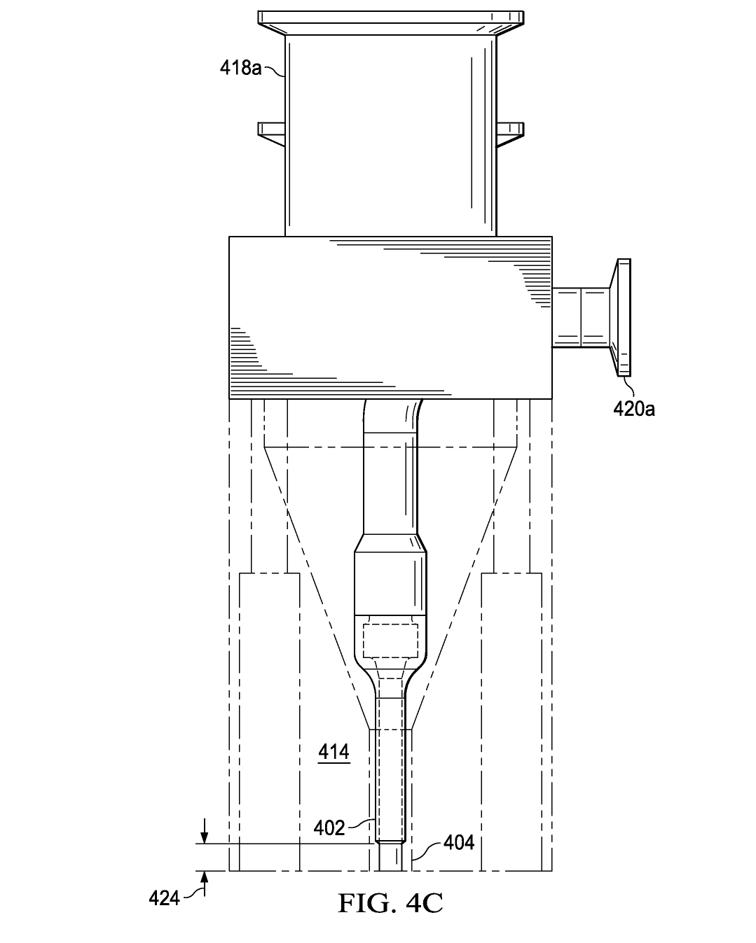

As another example, in one embodiment, the extrudate 200 is conveyed by a conveyor 406 (for example, as depicted in FIG. 4) at a faster linear velocity than the extrudate 200 is coextruded, thereby stretching a length of the extrudate 200 and shrinking a cross-sectional area of the extrudate 200.

Additionally, in one embodiment the filling 301 is coextruded 104 using pulses so that less filling 301 (e.g., no filling 301 or substantially no filling 301) is present where the substrate 201 is cut during the step of cutting 106 the extrudate 200.

Further, in one embodiment, the filling 301 comprises a non-dissolved, solid inclusion 800 with an equivalent spherical diameter 802 that does not exceed (e.g., has a maximum of, or is less than or equal to) ⅓ of an equivalent circular inner diameter 502a of a cross-section 512a of a nozzle 402a for the filling 301 at any point along the nozzle 402a for the filling 301.

FIG. 2 also shows a substrate 201 comprising three flaps 207, 208, 210. A fourth flap 211 is also present at the second end 203 of the substrate 201 but cannot be seen from the perspective view shown in FIG. 2. Although, the fourth flap 211 is visible in FIG. 2A. The four flaps are created when the substrate 201 is crimped. Although the flaps are relatively prominent, and noticeable in the embodiment of FIG. 2, in other embodiments the flaps may be smaller, less prominent and less noticeable. Alternatively, in some embodiment the flaps can be larger, more prominent, and more noticeable.

Although not shown in FIG. 2 or FIG. 3, the outer surface 206 of substrate 201 can be breaded or battered. Alternatively, the surface 206 can be both battered and breaded. For example, the surface 206 can be battered in one step and then breaded in a subsequent step. In some embodiments, the breading step directly follows the battering step. Additionally, while FIGS. 2 and 3 show an extrudate 200 and substrate 201 substantially in the form of the tube or cylinder with a circular cross-section, the extrudate 200, substrate 201, and filling 301 can be formed in other shapes or sizes, for example, the other shapes and sizes discussed herein.

With reference, for example, to FIG. 3, in one embodiment, the substrate 201 comprises about 1.0 to about 6.0 wt % corn syrup on a dry ingredient weight basis. Additionally, in one embodiment, the mass ratio of the substrate 201 to the filling 301 is about 70:30 to about 90:10, about 80:20 to about 90:10, or about 85:15. Although, in some embodiments the ratio can be modified, for example, to match consumer taste preferences.

One embodiment of the invention will now be described with reference to FIGS. 4, 4A, 4B, and 4C. As illustrated, for example, in FIG. 4, one embodiment comprises a controller 422 to control a process and apparatus for providing cut, crimped extrudate 412 from a substrate and a filling. For example, one embodiment comprises a substrate source (e.g., hopper 416), which is in fluid communication with a substrate feed line 418, which is in fluid communication with substrate sublines 418a,b,c,d (illustrated in FIGS. 4A, 4B, and 4C), which are in fluid communication with a die 414 comprising nozzles 404 for extruding the substrate. Furthermore, one embodiment comprises, a filling source (e.g., a hopper, which is not shown), which is in fluid communication with a filling feed line 420, which is in fluid communication with filling sublines 420a,b,c,d, which are in fluid communication with the die 414 comprising nozzles 402 for extruding the filling.

As illustrated in FIG. 4, an extrudate rope 410 is extruded from the die 414 onto a conveyor 406. After extrusion, the extrudate rope 410 is cut by a cutter and crimper 408 to provide cut, crimped extrudate 412. Although, the illustrated cutter and crimper 408 both cuts and crimps the extrudate rope 410, in some embodiments, a cutter and a crimper are separate devices.

FIGS. 4A, 4B and 4C are schematic views depicting a perspective view, a top view and a side (e.g., left) view, respectively, of one embodiment of the invention. As illustrated in FIGS. 4A, 4B, and 4C, a nozzle 404 for the substrate can surround a nozzle 402 for the filling. Furthermore, the nozzles 404 for the substrate can extend past the nozzle 402 for the filling by a distance 424.

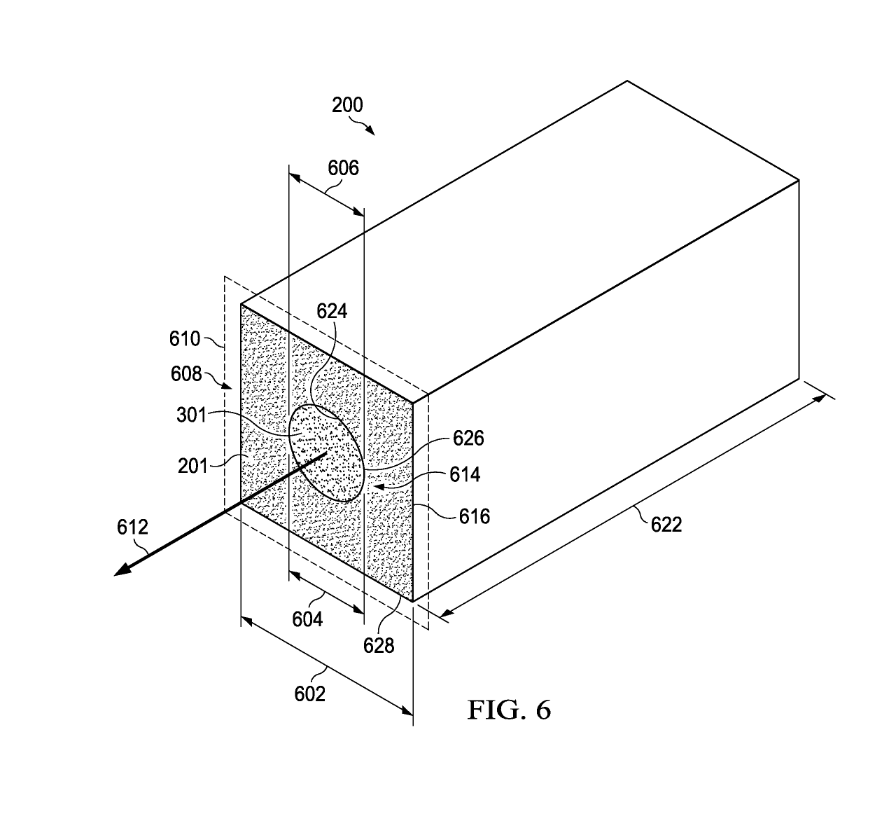

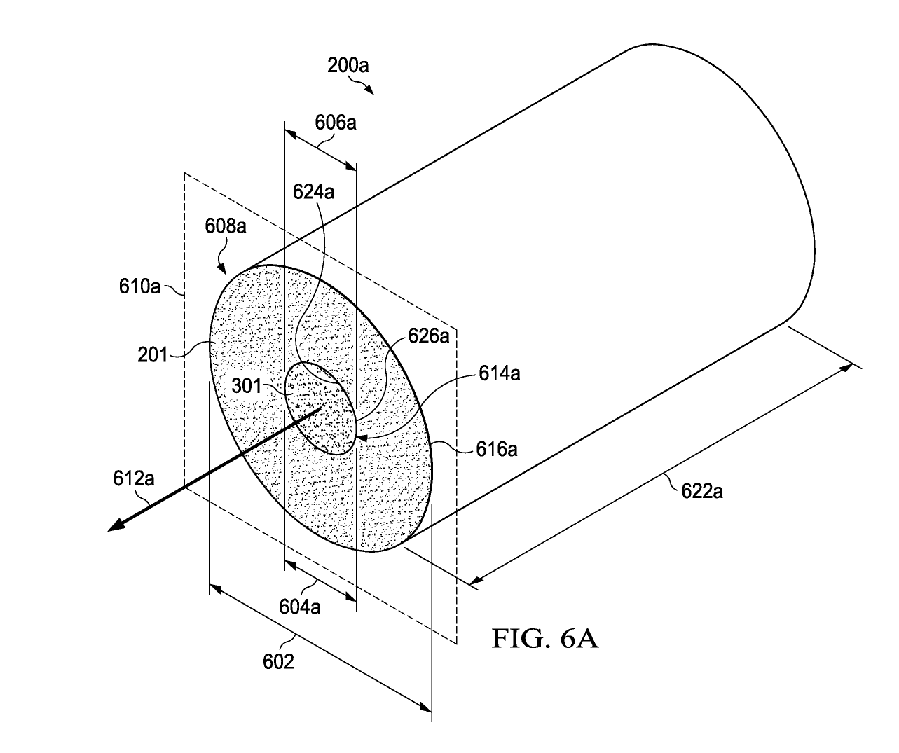

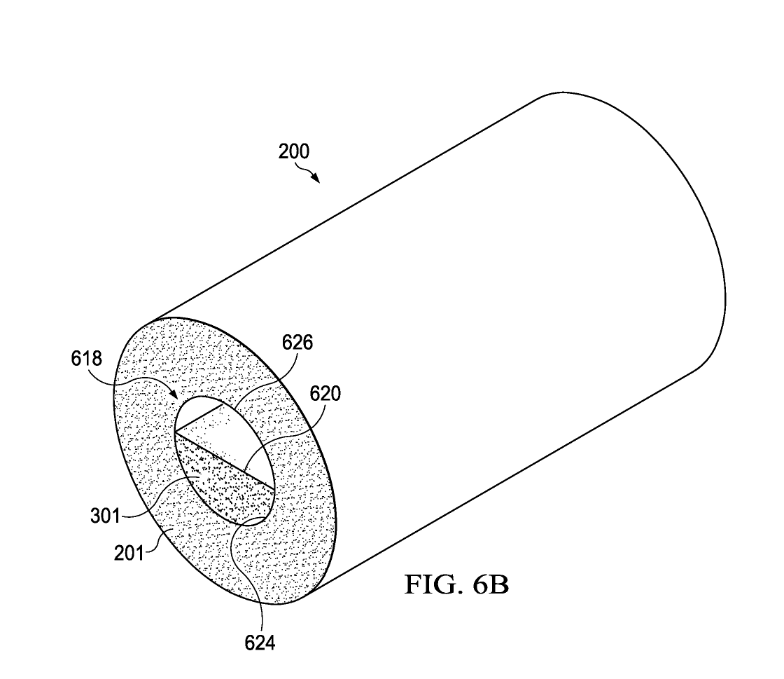

One embodiment of the invention will now be described with reference to FIGS. 6-6A. FIG. 6 shows an example of a first extrudate 200 comprising a rectangular- (e.g., square-) shaped outer perimeter 616 of the substrate 201. FIG. 6 also shows how a cross-section of the extrudate 200 comprises a cross-section 608 of the substrate 201 and a cross-section 614 of the filling 301. For example, as illustrated, cross-section 608 of the substrate 201 and/or filling 301 can be taken in a plane 610,610a perpendicular to a direction 612,612a of extrusion of the substrate 201 and/or a direction 612,612a of extrusion of the filling 301. Although, in FIGS. 6 and 6A, both the substrate 201 and filling 301 are extruded in the same direction.

FIG. 6A shows an example of a second extrudate 200a demonstrating the concept of equivalent circular diameters (e.g., equivalent circular inner and/or outer diameters). For ease of reference, the same or corresponding elements in FIG. 6 and FIG. 6A are denoted using the same reference numerals, although the elements in FIG. 6A have also been given an “a” suffix. For example, the inner diameter 604 of the substrate 201 in FIG. 6 is denoted by the reference numeral 604, while the inner diameter 604a of the substrate 201 in FIG. 6A is denoted by the reference numeral 604a. Accordingly, in some cases, elements are only discussed with respect to one figure, and not discussed individually with respect to both figures.

As illustrated, FIG. 6A illustrates an equivalent circular outer diameter 602a of a cross-section 608a of a substrate 201, an equivalent circular inner diameter 604a of a cross-section 608a of a substrate 201, and an equivalent circular outer diameter 606a of a cross-section 614a of a filling 301, which enclose the same area, respectively, as an outer perimeter 616 of a cross-section 608 of a substrate 201, an inner perimeter 626 of a cross-section 608 of a substrate 201, and an outer perimeter 624 of a cross-section 614 of a filling 301 illustrated in FIG. 6.

In one embodiment, an equivalent circular outer diameter 602a of a cross-section 608 of the substrate 201 is about 9-18 mm. As used herein, an equivalent circular outer diameter of a cross-section of a shape is the diameter of a circle having an area equal to the area enclosed by the outer perimeter of a cross-section of the shape. As used herein, an equivalent circular inner diameter of a cross-section of a shape is the diameter of a circle having an area equal to the area enclosed by the inner perimeter of a cross-section of the shape (if any). For example, given a substrate 201 with an annulus shaped cross-section, the equivalent circular inner diameter 604a of a cross-section 608a of the substrate 201 will be smaller than the equivalent circular outer diameter 602a of the cross-section 608a of the substrate 201. In one embodiment, an inner diameter 604 or an equivalent circular inner diameter 604a of a cross-section 608,608a of the substrate 201 is about 3-7 mm. In one embodiment, an outer diameter 606 or an equivalent circular outer diameter 606a of a cross-section 614,614a of the filling 301 is about 3-7mm.

In one embodiment, the substrate 201 comprises a length 622,622a in the direction 612,612a of extrusion with a range of about 38.1-127 mm (about 1.5-5 in.), or about 63.5 mm (about 2.5 in.). Although, when the substrate 201 is made in a continuous process (e.g., continuous extrusion), as illustrated, for example, in FIG. 4, the substrate 201 can be made to essentially any length.

As illustrated, for example, in FIG. 6, in one embodiment, a cross-section 608 of the substrate 201 comprises an outer perimeter 616 with a substantially square shape. Furthermore, in one embodiment, an edge 628 of an outer perimeter 616 of a cross-section 608 of the substrate 201 has a length (or width) 602 of about 8-16 mm. Although, in some embodiments, the outer perimeter 616a of a cross-section 608a of the substrate 201 has other shapes (e.g., circular).

With reference, to FIG. 6B, in one embodiment, a cross-sectional area 620 of the filling 301 is a fraction of a cross-sectional area 618 bounded by the substrate 201 (e.g., bounded by the inner perimeter 626 of a cross-section 608 of the substrate 201). In one embodiment, the fraction is about 0.4-0.9. Although, in some embodiments the cross-sectional area 620 of the filling 301 is equal to the cross-sectional area 618 bounded by the substrate 201 (e.g., bounded by the inner perimeter 626 of the substrate 201), because, for example, the filling 301 completely fills the substrate 201.

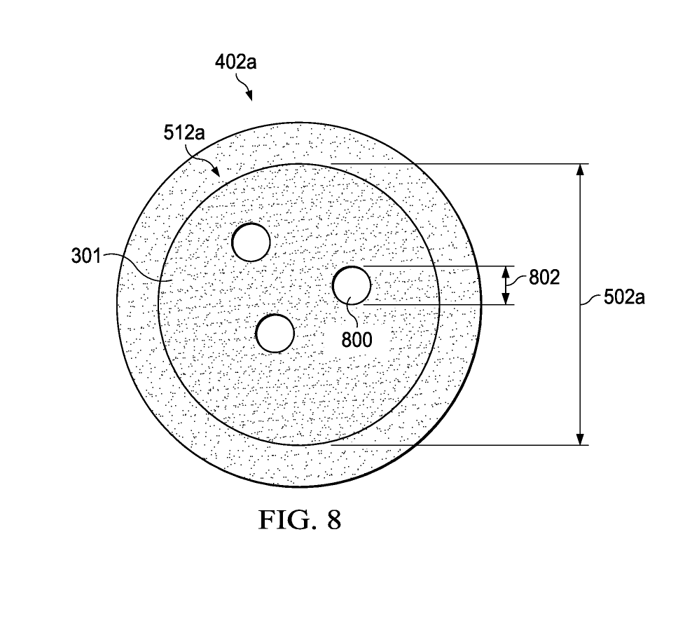

With reference to FIG. 8, in one embodiment, the filling 301 comprises a plurality of inclusions 800 with equivalent spherical diameters 802 at least as large as about 1 mm. As used herein, an equivalent spherical diameter 802 of an object is the diameter of a sphere having the same volume as the object, excluding pores or void spaces in the object.

In some embodiments, the substrate 201 and/or filling 301 comprises a component to lubricate the interface between the substrate 201 and/or filling 301 and a nozzle for extruding the substrate 201 and/or filling 301. For example, in one embodiment, the substrate 201 comprises an emulsifier, for example, an emulsifier selected from the group consisting of oil (e.g., vegetable oil), lecithin, monoglyceride and diglyceride.

In some embodiments, the substrate 201 and/or filling 301 comprises a component to prevent filling 301 from escaping from the substrate 201. For example, some embodiments of the substrate 201 comprise a component to strengthen the substrate 201. As illustrations, in one embodiment, the substrate 201 comprises a gum and/or an alginate (e.g., sodium alginate) and calcium ions (e.g., calcium chloride, calcium carbonate, etc.) available to react with the alginate to form a network (e.g., a gel) in the substrate 201 upon or after extrusion.

As another example, some embodiments of the filling 301 comprise a component to increase the viscosity of the filling 301 or otherwise prevent the filling 301 from flowing as easily. As an illustration, in one embodiment, the filling 301 comprises carboxy methyl cellulose (CMC). As another illustration, the filling 301 can comprise a gum (e.g., xanthan gum, guar gum, and carrageenan) and/or an alginate and calcium ions available to react with the alginate to form a network in the filling 301.

In one embodiment, an additional calcium ion nozzle can be used to supply calcium ions to the filling 301 and/or substrate 201 after the filling 301 and/or substrate 201 is extruded. For example, this can provide a mechanism for providing calcium ions between the substrate 201 and the filling 301 as the filling 301 exits a nozzle 402 for the filling 301, but before the filling 301 comes into contact with the substrate 201. In some embodiments, this can be done by coextruding the substrate 201, calcium ions, and filling 301.

Furthermore, in one embodiment, a nozzle for the substrate 201 can wrap around a nozzle for the calcium ions, and the nozzle for the calcium ions can wrap around the nozzle for the filling 301. Advantageously, extruding the calcium ions with the substrate 201 and/or filling 301, can avoid the need to react the calcium ions and alginate before the substrate 201 and/or filling 301 is extruded, which could complicate the extrusion process (e.g., by making it more difficult for the filling 301 and/or substrate 201 to flow through a nozzle). Additionally, in one embodiment, the nozzle for the calcium ions can extend past the nozzle 402 for the filling 301 by a distance (e.g., similar to the way the nozzle 404 for the substrate 201 extends past the nozzle 404 for the filling 301 in FIG. 4A) to prevent the network formed from the reaction between the calcium ions and the alginate from causing too much resistance to flow near the entrance of or inside the nozzle 402 for the filling 301.

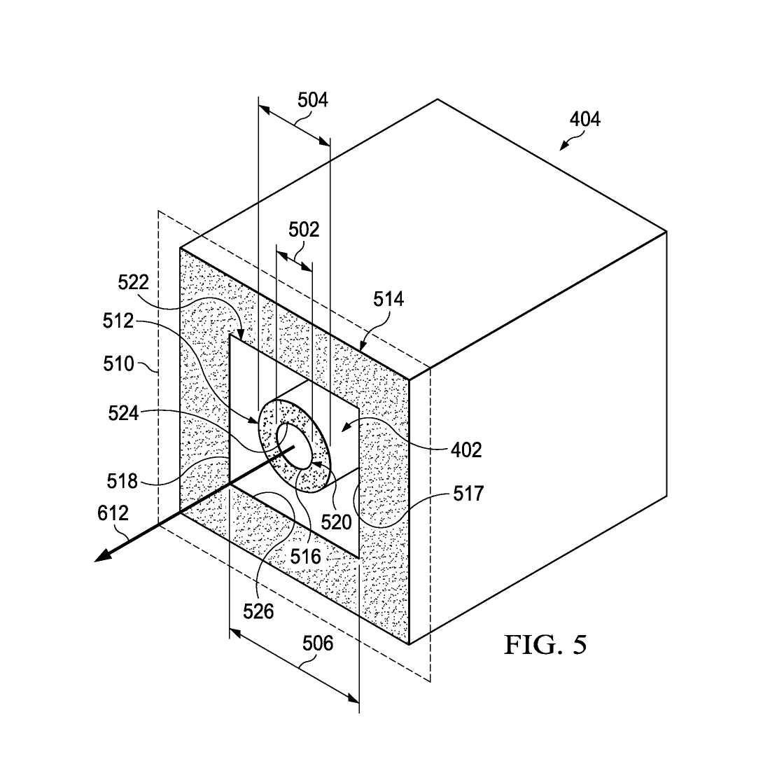

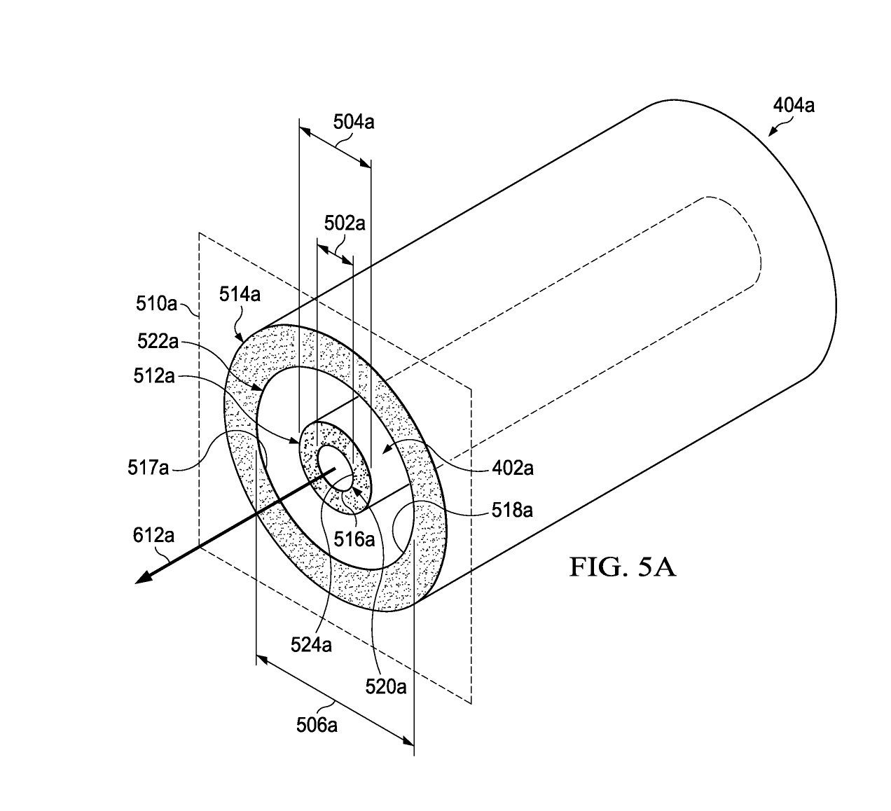

One embodiment of the invention will now be described with reference to FIG. 5 and FIG. 5A. FIG. 5 shows an example of a first nozzle 404 comprising a rectangular- (e.g., square-) shaped inner perimeter 518 of a nozzle for the substrate 201. FIG. 5 also illustrates a cross-section 514 of a nozzle 404 for the substrate 201 and a cross-section 512 of a nozzle 402 for the filling 301. For example, as illustrated, the cross-section 512,512a,514,514a of the nozzle for the substrate 201 and/or filling 301 can be taken in a plane 510,510a perpendicular to a direction 612,612a of extrusion of the substrate 201 and/or a direction 612,612a of extrusion of the filling 301. Although, in FIGS. 5 and 5A both the substrate 201 and filling 301 are extruded in the same direction.

FIG. 5A shows an example of a second nozzle 404a demonstrating the concept of equivalent circular diameters (e.g., equivalent circular inner and/or outer diameters). For ease of reference, elements in both FIG. 5 and FIG. 5A are generally denoted using the same reference numeral, although the elements in FIG. 5A have also been given an “a” suffix. For example, the length (or width) 506 of the inner perimeter 518 of the cross-section of a nozzle 404 for the substrate 201 in FIG. 5 is denoted by the reference numeral 506, while the inner diameter 506a of the nozzle 404a (corresponding to the inner perimeter 518a) for the substrate 201 in FIG. 5A is denoted by the reference numeral 506a.

With reference to FIGS. 5 and 5A, in one embodiment, an equivalent circular inner diameter 506a of a nozzle 404a for the substrate 201 is about 9-12.4 mm. For example, in one embodiment, an equivalent circular inner diameter 506a of a cross-section of the nozzle 404a for the substrate 201 is about 9-12.4 mm. As another example, in one embodiment, an equivalent circular inner diameter 506a of a cross-section of an outlet 517a of the nozzle 404a for the substrate 201 is about 9-12.4 mm.

In one embodiment, an outer diameter 504 or an equivalent circular outer diameter 504a of a nozzle 402,402a for the filling 301 is about 6.8-8.6 mm. For example, in one embodiment, an outer diameter 504 or an equivalent circular outer diameter 504a of a cross-section 512,512a of the nozzle 402,402a for the filling 301 is about 6.8-8.6 mm. As another example, in one embodiment, an outer diameter 504 or an equivalent circular outer diameter 504a of a cross-section 512,512a of an outlet 516,516a the nozzle 402,402a for the filling 301 is about 6.8-8.6 mm.

In one embodiment, an inner diameter 502 or an equivalent circular inner diameter 502a of a nozzle 402,402a for the filling 301 is about 4.8-6.6 mm. For example, in one embodiment, an inner diameter 502 or an equivalent circular inner diameter 502a of a cross-section 512,512a of the nozzle 402,402a for the filling 301 is about 4.8-6.6 mm. As another example, in one embodiment, an inner diameter 502 or an equivalent circular inner diameter 502a of a cross-section 512,512a of the outlet 516,516a the nozzle 402,402a for the filling 301 is about 4.8-6.6 mm.

In one embodiment, a cross-section 514 of a nozzle 404 for the substrate 201 comprises an inner perimeter 518 with a substantially square shape. Furthermore, in one embodiment, an edge 526 of an inner perimeter 518 of a cross-section 514 of the nozzle 404 for the substrate 201 has a length (or width) of about 8-11mm.

In one embodiment, a cross-sectional area 520,520a bounded by an inner perimeter 524,524a of a nozzle 402,402a for the filling 301 is a fraction of the cross-sectional area 522,522a bounded by an inner perimeter 518,518a of a nozzle for the substrate 201, wherein the fraction is about 0.1-0.5.

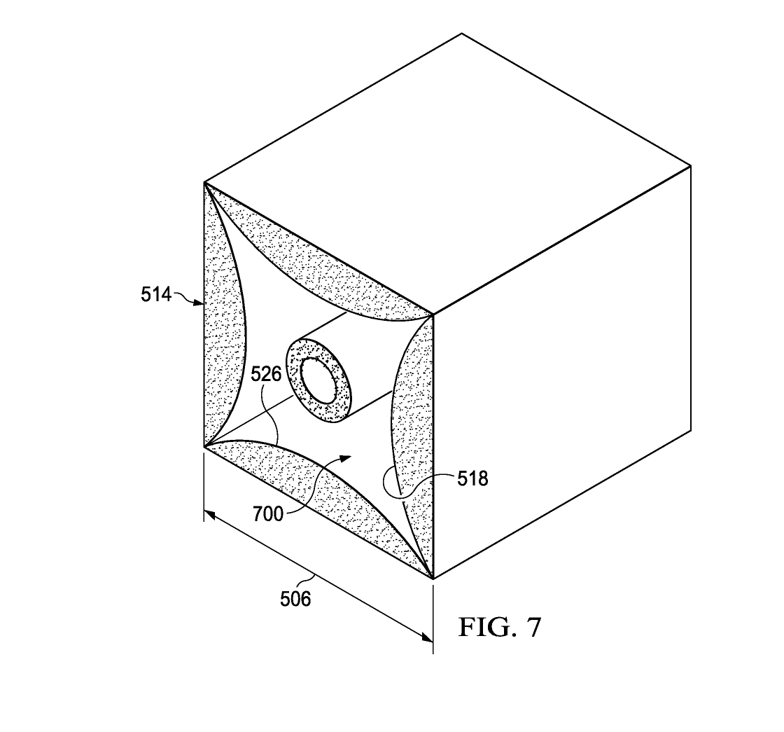

With reference to FIG. 7, in one embodiment, a cross-section of a nozzle for the substrate 201 comprises an inner perimeter 518 with a shape that comprises edges 526 (e.g., four edges) with substantially equal lengths (or widths) 506. Furthermore, in one embodiment, each edge 526 is convex relative to a space 700 bounded by the inner perimeter 518.

### COMPARATIVE EXAMPLES

Several compositions for substrates and fillings have been tested. Illustrative examples of compositions according to the invention are provided below.

### Example Set 1

Several experiments were conducted to test substrates for extrudability, susceptibility to crimping, ability to protect a filling during frying, and organoleptic properties of substrates after preparation for consumers. Fillings were also tested for extrudability. The dough formulations in Table 1 produce a potato-based dough with pie dough-like rheological characteristics that can be par fried before freezing to improve organoleptic characteristics and process feasibility.

TABLE 1
Substrate Formulations

| | Formulation 1 | Formulation 2 |
|---|---|---|
| Ingredient | wt % | wt % |
| Potato Flakes | 37.9 | 37.22 |
| Corn Starch | 10.0 | 9.9 |
| Potato Granules | 5.9 | 5.8 |
| Salt | 1.2 | 1.2 |
| Emulsifier | 0.39 | 0.38 |
| High Fructose | 1.5 | 3.0 |
| Corn Syrup | | |
| Water | 43.2 | 42.5 |
| Total | 100.0 | 100.0 |

In some embodiments, the substrate comprises a predominant dry component that is a starch. Although in the example shown in Table 1 a primary dry ingredient by weight is potato, in other embodiments the primary ingredient by weight comprises at least one of a vegetable, a meat, a legume, or a starch. For example, in one embodiment a starch is selected from the group consisting of potatoes, corn, chickpeas, hummus, granola, oats, grain, refined grains, whole grains, rice, wheat, sweet potatoes, or some combination thereof. In some embodiments, the use of a finer sized potato flake promotes increased hydration of the dough, for example, due to the increased flake surface area relative to volume. This can be useful to obtain a desired dough water content. Increased water content in the dough can, in turn, aid material flow through an extruder die and can result in thicker extrudate ropes. Thicker ropes (e.g. ropes comprising a thicker dough substrate) can help to protect a filling in the extrudate.

In some embodiments, the addition of High Fructose Corn Syrup increased the susceptibility of the dough to crimping, for example, by increasing the stickiness of the dough. Stickier dough can help the dough hold a crimp better as opposed to releasing the crimp.

As used in Table 1, an example of a potato flake is a dehydrated potato flake available from Idaho Pacific of Rigby, Id., USA. An example of potato granules are the potato granules available from Idaho Pacific of Rigby, Id., USA. An example of a corn starch is Ultracrisp modified corn starch. It is a waxy corn starch. The term “waxy” indicates the cornstarch comprises substantially only Amylopectin as opposed to both Amylose and Amylopectin. Waxy corn starch can provide an expanded texture when fried. Ultracrisp modified corn starch is available from Ingredion of Bridgewater, N.J., USA.

Although Table 1 provides examples of substrates in accordance with the invention, in other embodiments, the substrate comprises about 2.5 to about 7.5 wt % high fructose corn syrup on a dry ingredient basis (i.e. high fructose corn syrup is 2.5 to 7.5 wt % of all the ingredients in the substrate excluding water added). In some embodiments, the substrate comprises about 30 to 50 wt % water added (i.e. water is 30 to 50 wt % of the combined mass of the dry ingredients and wet ingredients, e.g., water, that are combined to form the substrate).

Furthermore, some embodiments of the substrate can include yeast extract, which, for example, can yield increased cooked potato notes and positively influence the color of the product by making the substrate darker. In some embodiments, the substrate can comprise flavored oil, which can provide the characteristic flavor of a cooked French fry. In some embodiments, the dough can also be darkened by adding dextrose or baking soda. Baking soda, however, can also be used to obtain a desired product expansion or texture.

In some embodiments, the shape of the dough and the extrudate can be changed by using extrusion die inserts designed to produce different shapes (e.g. a square French fry shape as opposed to a round tube shape).

In one embodiment, the coextruder filling nozzle can have an outside diameter (or outside length and width) of about 2.60″ and an inside diameter (or inside length and width) of about 0.50″×0.50″. The inventors believe that an embodiment with these dimensions can be desirable, for example, because it will produce a traditional French fry shape. Although, other embodiments use other nozzle dimensions and shapes and produce differently sized and differently shaped extrudate.

The substrates in Table 1 were tested with a corresponding filling from Table 2 and 3. Table 2 shows the cheese filling that was used with dough Formulation 1.

TABLE 2
Filling Formulation 1

| Ingredient | wt % |
|---|---|
| CHEESE, MONTEREY JACK | 11.0000 |
| VEGETABLE OIL | 7.0000 |
| MODIFIED STARCH | 5.0000 |
| MALTODEXTRIN | 5.0000 |
| PROTEIN CONCENTRATE (80% | 2.0000 |
| DAIRY AND/OR SOY) | |
| NATURAL CHEESE FLAVORS | 1.6000 |
| FIBER (CORN, CITRUS, AND/OR | 1.0000 |
| BAMBOO) | |
| SALT | 1.0000 |
| PHOSPHATE | 0.4000 |
| MSG | 0.3000 |
| EMULSIFIER (OIL IN WATER TYPE) | 0.3000 |
| COLOR | 0.0160 |
| WATER, ROOM TEMPERATURE | 65.3840 |
| TOTAL | 100.0000 |

Analysis of the filling formulation of Table 2 indicated that the filling had a total water content of 77 wt %, a pH of 5.7, and a water activity of 0.990.

As used in Table 2, an example of a phosphate would be Yoha S-9 available from ICL Food Specialties Saint Louis, Mo. USA. An example of fiber (e.g. corn fiber) is Z-Trim available from Z-Trim Ingredients of Mundelein, Ill., USA.

In making the filling embodiment of Table 2, the following procedures were used. First, the cheese was ground by extruding the cheese using a Kitchen Aid mixer equipped with the mixer's food grinder attachment. Second, the high speed mixer was used to blend 70% of the water, oil, ground cheese, protein, flavor, salt, phosphate, MSG, emulsifier, and colors to form a uniform mixture. Third, the mixture is heated to 160-170° F. in a double boiler, and homogenized. Forth, the starch is suspended in the remaining water and added to the homogenate. Fifth, the fiber is slowly blended into the mixture while mixing at high speed until the desired viscosity is achieved. In some embodiments, the fifth step is the final step for obtaining the filling.

In making the filling described in Table 2, a few subsidiary procedures are also useful. For example, in one embodiment, the fiber is added to the mixture of ingredients to obtain a desired texture in the presence of shear force. The desired texture is similar to peanut butter, for example, the mixture has a viscosity of 250,000 cps. Additional water is added if the other ingredients, including the water previously added, are too thick to homogenize. In the embodiment shown in Table 2, the mixture of ingredients was homogenized before extrusion. The homogenized filling had the texture of peanut butter after it was thickened with fiber. The thickness of peanut butter was targeted because the RBS coextrusion line used for the test was originally designed for filling pretzels with peanut butter. For example, in some extrusion units, the flow of the filling cannot be controlled unless there is an adequate backpressure in the filling nozzles. In some embodiments the back pressure is controlled by either using a smaller filling nozzle or a thicker filling. Accordingly, while the thickness of peanut butter was selected for the filling in this example, other thicknesses can be selected depending on the equipment used to extrude a product. Similar considerations can be relevant for selecting the thickness, rheological properties, or other characteristics related to the extrudability of a substrate (e.g. dough).

The inventors noticed that as thickness is increased (e.g., by adding thickeners), the cheese flavor becomes muted. Accordingly, additional cheese flavor was added to counteract the muting of the cheese flavor with the addition of thickeners.

The filling of Table 2 was tested for extrudability on a Reading Bakery Systems filled pretzel extruder. Additional fiber was added (e.g. bamboo fiber) to the homogenate to optimize the texture for extrusion. For example, a mass of bamboo fiber equal to about 7.69 wt % of the cheese filling of Table 2 can be added to the cheese filling to provide a back pressure of approximately 3 psi. Even when the cheese filling is not as thick as the ketchup filling, in some embodiments the cheese filling has a higher back pressure through the extruder nozzle than the ketchup filling. Although the inventors do not wish to be bound by theory, it is believed that the cheese filling has a higher back pressure due to the higher fat and protein content, which, for example, causes more resistance to flow than embodiments without the higher fat and protein content. In some embodiments, the higher fat and protein content provides resistance to flow that more closely approximates the characteristics of peanut butter.

Table 3 shows the ketchup filling that was used with substrate (e.g. dough) Formulation 2. In one embodiment, the mass ratio of substrate to filling was about 55:45, although in other embodiments the ratio can be different.

TABLE 3
Filling Formulation 2

| Ingredient | wt % |
|---|---|
| TOMATOCONCENTRATE (0.060″ | 48.00 |
| FINISH, 26% NTSS) | |
| DARK BROWN SUGAR | 25.17 |
| VINEGAR (120 GRAIN) | 21.20 |
| OLIVE OIL | 4.30 |
| ONION POWDER | 0.60 |
| SALT | 0.55 |
| XANTHAN GUM | 0.10 |
| CORN FIBER | 0.08 |
| ADDITIONAL WATER | 0.00 |
| TOTAL | 100 |

Analysis of the filling formulation of Table 3 indicated that the filling had a total water content of 54.4 wt %, a pH of less than 3.9 (i.e. 3.86), and a water activity of 0.932

The term 0.06″ finish indicates that the concentrate has been screened with a finish screen with a hole or pore size of 0.06″. The term 26% NTSS indicates that the concentrate comprises 26 wt % natural tomato soluble solids. For example, a 26% NTSS concentrate could comprise 26% tomato solids and 74% water by weight. The water present in the filling of Table 3 is from the crushed tomato concentrate and vinegar. Xanthan gum is added to bind up the ketchup and to increase extrudability.

In making the filling of Table 3, the dry ingredients were mixed together to form a dry ingredient mixture. Then the dry ingredient mixture was mixed into the vinegar to form a vinegar mixture. The vinegar mixture was then mixed vigorously into tomato paste using a high speed/shear mixer to form a tomato paste mixture. The final tomato paste mixture was thickened using corn fiber. In some embodiments, more fiber or less fiber is added to achieve a desired consistency, thickness, or viscosity. In making the filling formulation of Table 3, the fiber was slowly blended into the tomato mixture while mixing at high speed until the desired viscosity was achieved. In some embodiments the mixture (including the fiber) is subject to shear until smooth. Although not shown in Table 3, additional vinegar was added to fine tune the ketchup filling to a targeted pH of less than 3.9.

The ingredients of Table 3 were mixed to provide a filling with a thickness approximately like that of peanut butter so the filling would be extrudable and provide adequate back pressure during extrusion. To the extent that a greater thickness is necessary for extrudability (e.g. to provide back pressure), additional fiber can be added to the filling. This is generally described with respect to the cheese filling of Table 2. For example, a mass of bamboo fiber equal to about 3 wt % of the ketchup filling of Table 3 can be added to the ketchup filling to provide a back pressure of approximately 1.5 psi.

The substrate formulations shown in Table 1 and their corresponding fillings shown in Table 2 were subjected to trial extrusion conditions as shown in Table 4:

TABLE 4
Extrusion Process Conditions

| Parameter | Formulation 1 | Formulation 2 |
|---|---|---|
| Outer Orifice Diameter, mm | 9 | 9 |
| Inner Diameter/Outer Diameter of | 1.8/2.6 | 1.8/2.6 |
| Inner Nozzle, mm | | |
| Water Temperature, ° F. | 95 | 95 |
| Dough Temperature, ° F. | 100 | 90 |
| Dough Moisture, % | 43 | 43.2 |
| Extrudate Temperature, ° F. | 72 | 77 |
| Extruder Dough Pressure, psig | 90 | 90 |
| Retention Time, seconds | 470 | 470 |
| Number of Open Orifices | 6 | 6 |
| Filling Type | Cheese | Ketchup |
| Filling Temperature, ° F. | 52 | 65 |

The substrates and fillings as described in Tables 1-4 were extruded using a cold-coextrusion, filled-pretzel extruder line available from Reading Bakery Systems (RBS). The extruder dough pressure in Table 4 is the pressure behind the extruder die, experienced by the substrate (e.g., dough), given in gauge pressure.

Several substrate and filling combinations were tested by the inventors as shown below in Table 5:

TABLE 5
Substrate Formulations

| | Formulation 1 | Formulation 2 | Formulation 3 |
|---|---|---|---|
| Ingredient | wt % | wt % | wt % |
| Potato Flakes | 37.15 | 36.90 | 36.86 |
| Corn Starch | 9.86 | 9.79 | 9.78 |
| Potato Granules | 5.76 | 5.72 | 5.72 |
| Salt | 1.35 | 1.34 | 1.34 |
| Emulsifier | 0.38 | 0.54 | 0.53 |
| High Fructose | 3.03 | 3.01 | 0.00 |
| Corn Syrup | | | |
| Water | 42.46 | 42.17 | 44.70 |
| Oil | 0.00 | 0.54 | 1.07 |
| Total | 100.0 | 100.0 | 100.0 |

The tests shown in Table 5 used a Vemag HP-E machine to provide the substrate to a substrate extrusion nozzle and a Vemag ROBOT 500 machine to provide the filling to a filling extrusion nozzle. However, other extrusion machines can also be used with the invention described herein. Both the Vemag HP-E and the Vemag ROBOT 500 are available from Reiser Inc., 725 Dedham Street, Canton, Mass. 02021, US.

In the exemplary substrate formulations shown in Table 5, the substrate was a dough, the emulsifier was lecithin and the oil was canola oil. Substrate formulation 1 was run with a ketchup filling continuously coextruded within the substrate. The substrate exhibited a relatively high frictional pressure loss as if flowed through the extruder machine and out the extrusion nozzle. As a result of the relatively higher frictional pressure drop, the extrusion machine drew current at 27 Amps and a given fixed voltage, resulting in a relatively higher power usage. Substrate formulation 2 was run with a ketchup filling coextruded within the substrate in a pulsed pattern. Substrate formulation 3 was run with a cheese filling coextruded within the substrate in a pulsed pattern. Substrate formulation 3 used no corn syrup to reduce browning. Additionally, substrate formulation 3 included more oil, resulting in relatively lower frictional pressure drop. As a result of the relatively lower frictional pressure drop, the extrusion machine drew current at 15 Amps and the same fixed voltage, resulting in relatively less power usage.

As described herein, the invention, in its various embodiments provides several advantages. For example, in one embodiment the invention provides an improved composition and method for making stuffed fries on a commercial scale. In one embodiment, the invention provides a composition and method for making a stuffed fry with a filling that does not escape from the dough during cooking. Additionally, one embodiment provides a composition and method for making a stuffed fry dough that is not soggy, too oily, or too dry and meets consumer expectations for texture, such as crispiness, flakiness, crunchiness, brownness, or other characteristics. Furthermore, one embodiment provides a stuffed fry that comprises a dough and filling that satisfy consumer expectations with respect to organoleptic properties while simultaneously satisfying requirements for processing (e.g., flowability, extrudability, susceptibility to crimping, susceptibility to browning, ability to stretch, ability to expand, etc.).

Unless otherwise indicated, all numbers expressing compositions, distances, temperatures, pressures and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. Notwithstanding that the numerical ranges and parameters setting forth the broad scope of the invention are approximations, the numerical values set forth in the specific examples are reported reasonably precisely. Any numerical value, however, inherently contains certain errors necessarily resulting from the standard deviation found in their respective testing measurements.

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### ADDITIONAL EMBODIMENTS

Additional embodiments of the invention are listed below.

1. A food product comprising an extrudate, said extrudate comprising:

a coextruded substrate and filling;

wherein the substrate comprises:
at least one vegetable, meat, legume, or starch,
about 30 to about 50 wt % water on a total-substrate-weight basis; and
crimped ends;

wherein the filling comprises about 40 to about 70 wt % water; and

wherein the mass ratio of the substrate to the filling is about 90:10 to about 50:50.

2. The food product of embodiment 1 or 60, wherein the substrate comprises about 2.0 to about 4.0 wt % corn syrup on a dry-ingredient-weight basis.

3. The food product of embodiment 1 or 60, wherein the substrate comprises about 35 to about 45 wt % water on a total-substrate-weight basis.

4. The food product of embodiment 1 or 60, wherein the filling comprises about 50 to about 60 wt % water.

5. The food product of embodiment 1 or 60, wherein the mass ratio of substrate to filling comprises about 60:30 to about 50:50.

6. The food product of embodiment 1 or 60, wherein the extrudate is cold-extruded.

7. The food product of embodiment 1 or 60, wherein the substrate is battered.

8. The food product of embodiment 1 or 60, wherein the substrate is battered and breaded.

9. The food product of embodiment 1 or 60, wherein the crimped ends completely seal the filling inside the substrate.

10. The food product of embodiment 1 or 60, wherein the substrate comprises a dough.

11. The food product of embodiment 1 or 60, wherein the substrate comprises at least one of a vegetable, a meat, a legume, or a starch.

12. The food product of embodiment 1 or 60, wherein the substrate comprises potatoes.

13. The food product of embodiment 1 or 60, wherein the filling comprises a dairy-based, meat-based, fruit-based, legume-based, or vegetable-based material.

14. The food product of embodiment 1 or 60, wherein the filling comprises at least one of ketchup, cheese, or sour cream.

15. The food product of embodiment 1 or 60, wherein the filling comprises an inclusion, said inclusion comprising a dairy-based, meat-based, fruit-based, legume-based, or vegetable-based material.

16. The food product of embodiment 1 or 60, wherein a shape of the substrate is selected from the group consisting of a tube, cylinder, rectangular-prism, taquito, burrito, pouch, pocket, churro, pillow or triangular-prism.

17. The food product of embodiment 1 or 60, wherein the food product is cooked in a cooking step, wherein the cooking step comprises finally cooking, final frying, par frying or partially cooking

18. The food product of embodiment 1 or 60, wherein the food product is cooked in a cooking step and cooled in a cooling step,

wherein the cooking step comprises finally cooking, final frying, par frying or partially cooking, and

wherein the cooling step comprises refrigerating or freezing.

19. The food product of embodiment 1 or 60, wherein the food product is cooked in a first cooking step, cooled in a cooling step, and cooked in a second cooking step,

wherein the first cooking step comprises finally cooking, baking, final frying, par frying or partially cooking,

wherein the cooling step comprises refrigerating or freezing, and

wherein the second cooking step comprises finally cooking, final frying, or reheating.

20. A method for making a food product, said method comprising the steps of:

coextruding a substrate and a filling to form an extrudate;

cutting the extrudate;

crimping the extrudate;

cooking the extrudate a first time;

wherein the substrate comprises:
at least one vegetable, meat, legume, or starch;
about 30 to about 50 wt % water on a total-substrate-weight basis; and
crimped ends;

wherein the filling comprises about 40 to about 70 wt % water; and

wherein the mass ratio of the substrate to the filling is about 90:10 to about 50:50.

21. The method of embodiment 20 or 62, wherein the step of crimping further comprises completely sealing the filling within the substrate.

22. The method of embodiment 20 or 62, wherein the method further comprises the step of battering the extrudate after said cooking step.

23. The method of embodiment 22, wherein the method further comprises the step of breading the extrudate after said cooking step.

24. The method of embodiment 20 or 62, wherein the step of cooking the extrudate a first time further comprises par frying the extrudate.

25. The method of embodiment 20 or 62, wherein the method further comprises the step of cooling the extrudate.

26. The method of embodiment 20 or 62, wherein the method further comprises the step of freezing the extrudate.

27. The method of embodiment 20 or 62, wherein the method further comprises the step of cooking the extrudate a second time.

28. The method of embodiment 26, wherein the method further comprises the step of cooking the extrudate a second time by final frying the extrudate or baking the extrudate.

29. The method of embodiment 20 or 62, wherein the step of cooking the extrudate a first time comprises par frying the extrudate, and wherein the method further comprises the steps of freezing the extrudate after par frying the extrudate, and final frying the extrudate after freezing the extrudate.

30. The method of embodiment 29, wherein the par frying the extrudate comprises par frying for about 30 seconds to 3 minutes at about 100 to 350° F., wherein the freezing the extrudate comprises reducing the temperature of the extrudate to less than about 5 ° F., and wherein the final frying the extrudate comprises final frying for about 45 seconds to 2 minutes at about 300 to 400° F.

31. The method of embodiment 29, wherein the par frying the extrudate comprises par frying for about 30 seconds to 2 minutes at about 200 to 350° F., wherein the freezing the extrudate comprises reducing the temperature of the extrudate to less than about 10° F., and wherein the final frying the extrudate comprises final frying for about 45 seconds to 2 minutes at about 300 to 400° F.

32. The method of embodiment 29, wherein the par frying the extrudate comprises par frying for about one minute at about 250° F., wherein the freezing the extrudate comprises reducing the temperature of the extrudate to less than about 10° F., and wherein the final frying the extrudate comprises final frying for about 1 minute at about 350° F.

33. The method of embodiment 20 or 62, wherein the method further comprises forming the food product of an embodiment selected from the group of embodiments consisting of embodiments 1-19, 35-48, and 60-61.

34. The method of embodiment 20 or 62, wherein the method further comprises forming the food product of at least one embodiment selected from the group of embodiments consisting of embodiments 1-19, 35-48, and 60-61, and a combination of embodiments 1-19, 35-48, and 60-61.

35. The food product of embodiment 1 or 60, wherein the substrate comprises about 1.0 to about 6.0 wt % corn syrup on a dry ingredient weight basis.

36. The food product of embodiment 1 or 60, wherein the mass ratio of the substrate to the filling is about 70:30 to about 90:10.

37. The food product of embodiment 1 or 60, wherein an equivalent circular outer diameter of a cross-section of the substrate is about 9-18 mm.

38. The food product of embodiment 1 or 60, wherein an equivalent circular inner diameter of a cross-section of the substrate is about 3-7 mm.

39. The food product of embodiment 1 or 60, wherein an equivalent circular outer diameter of a cross-section of the filling is about 3-7mm.

40. The food product of embodiment 1 or 60, wherein a cross-section of the substrate comprises an outer perimeter with a substantially square shape.

41. The food product of embodiment 1 or 60, wherein a cross-sectional area of the filling is a fraction of a cross-sectional area bounded by the substrate, wherein the fraction is about 0.4-0.9.

42. The food product of embodiment 1 or 60, wherein the substrate comprises a length in the direction of extrusion with a range of 38.1-127 mm.

43. The food product of embodiment 1 or 60, wherein the substrate comprises an emulsifier selected from the group consisting of oil, lecithin, monoglyceride and diglyceride.

44. The food product of embodiment 1 or 60, wherein the substrate comprises an alginate, and wherein the substrate comprises calcium ions available to react with the alginate to form a network.

45. The food product of embodiment 1 or 60, wherein the substrate comprises at least one component selected from the group consisting of a gum and a network formed from an alginate and calcium ions.

46. The food product of embodiment 1 or 60, wherein the filling comprises at least one component selected from the group consisting of carboxy methyl cellulose, an alginate, and a gum.

47. The food product of embodiment 1 or 60, wherein the food product is cooked in a first cooking step, cooled in a cooling step, and cooked in a second cooking step,

wherein the first cooking step comprises finally cooking, baking, or final frying,

wherein the cooling step comprises refrigerating or freezing, and

wherein the second cooking step comprises reheating.

48. The food product of embodiment 1 or 60, wherein the food product is cooked in a first cooking step, cooled in a cooling step, and cooked in a second cooking step,

wherein the first cooking step comprises par frying or partially cooking,

wherein the cooling step comprises refrigerating or freezing, and

wherein the second cooking step comprises finally cooking, or final frying.

49. The method of embodiment 20 or 62, wherein the substrate comprises about 1.0 to about 6.0 wt % corn syrup on a dry ingredient weight basis.

50. The method of embodiment 20 or 62, wherein an equivalent circular inner diameter of a nozzle for the substrate is about 9-12.4 mm.

51. The method of embodiment 20 or 62, wherein an equivalent circular outer diameter of a nozzle for the filling is about 6.8-8.6 mm.

52. The method of embodiment 20 or 62, wherein an equivalent circular inner diameter of a nozzle for the filling is about 4.8-6.6 mm.

53. The method of embodiment 20 or 62, wherein a cross-section of a nozzle for the substrate comprises an inner perimeter with a substantially square shape.

54. The method of embodiment 20 or 62, wherein a cross-sectional area bounded by an inner perimeter of a nozzle for the filling is a fraction of the cross-sectional area bounded by an inner perimeter of a nozzle for the substrate, wherein the fraction is about 0.1-0.5.

55. The method of embodiment 20 or 62, wherein a cross-section of a nozzle for the substrate comprises an inner perimeter with a shape that comprises 4 edges with substantially equal lengths, wherein each edge is convex relative to a space bounded by the inner perimeter.

56. The method of embodiment 20 or 62, wherein the extrudate is conveyed by a conveyor at a faster linear velocity than the extrudate is coextruded, thereby stretching a length of the extrudate and shrinking a cross-sectional area of the extrudate.

57. The method of embodiment 20 or 62, further comprising coextruding the filling using pulses so that less filling is present where the substrate is cut during the step of cutting the extrudate.

58. The method of embodiment 20 or 62, wherein the filling comprises a non-dissolved, solid inclusion with an equivalent spherical diameter that does not exceed ⅓ of an equivalent circular inner diameter of a cross-section of a nozzle for the filling at any point along the nozzle for the filling.

59. The method of embodiment 20 or 62, wherein the method further comprises the steps:

freezing the extrudate;

battering the extrudate with a starch

resting the extrudate; and

cooking the extrudate;

wherein the steps are ordered as follows:
(1) coextruding the substrate and the filling to form an extrudate;
(2) cutting the extrudate;
(3) crimping the extrudate;
(4) freezing the extrudate;
(5) battering the extrudate with the starch;
(6) cooking the extrudate the first time;
(7) resting the extrudate;
(8) cooking the extrudate the second time.

60. A cooked food product formed by cooking an extrudate, said extrudate comprising:
a coextruded substrate and filling;
wherein the substrate comprises:
   at least one component selected from the group consisting of a vegetable, meat, legume, and starch; and
   about 30 to about 50 wt % water on a total-substrate-weight basis;
wherein the filling comprises:
   about 40 to about 70 wt % water; and
   at least one gum (e.g., to reduce free water in the filling by binding to water in the filling); and
wherein a mass ratio of the substrate to the filling is about 90:10 to about 50:50.

61. The cooked food product of embodiment 60, wherein the at least one gum is selected from the group consisting of a network formed from an alginate and calcium ions, xanthan gum, guar gum, and carrageenan.

62. A method for making a food product, said method comprising the steps of:
coextruding a substrate and a filling to form an extrudate;
cutting the extrudate; cooking the extrudate a first time;
wherein the substrate comprises:
   at least one component selected from the group consisting of a vegetable, meat, legume, and starch; and
   about 30 to about 50 wt % water on a total-substrate-weight basis;

wherein the filling comprises:
about 40 to about 70 wt % water; and
at least one gum (e.g., to reduce free water in the filling by binding to water in the filling); and
wherein a mass ratio of the substrate to the filling is about 90:10 to about 50:50.

63. The method of embodiment 62, wherein the at least one gum is selected from the group consisting of a network formed from an alginate and calcium ions, xanthan gum, guar gum, and carrageenan.

We claim:

1. A cooked food product formed by cooking an extrudate, said extrudate comprising:
a coextruded substrate and filling;
wherein the substrate comprises:
at least one component selected from the group consisting of a vegetable, meat, legume, and starch; and
about 30 to about 50 wt % water on a total-substrate-weight basis;
wherein the filling comprises:
about 40 to about 70 wt % water; and
at least one gum; and
wherein a mass ratio of the substrate to the filling is about 90:10 to about 50:50.

2. The food product of claim 1, wherein the extrudate is cold-extruded.

3. The food product of claim 1, wherein the substrate is battered.

4. The food product of claim 1, wherein the ends are crimped and the crimped ends completely seal the filling inside the substrate.

5. The food product of claim 1, wherein the substrate comprises a dough.

6. The food product of claim 1, wherein the substrate comprises potatoes.

7. The food product of claim 1, wherein the filling comprises at least one component selected from the group consisting of ketchup, cheese, and sour cream.

8. The food product of claim 1, wherein the filling comprises an inclusion, said inclusion comprising a component selected from the group consisting of a dairy-based, meat-based, fruit-based, legume-based, and vegetable-based material.

9. The food product of claim 1, wherein a shape of the substrate is selected from the group consisting of a tube, cylinder, rectangular-prism, taquito, burrito, pouch, pocket, churro, pillow and triangular-prism.

10. The food product of claim 1, wherein the extrudate is cooked in a first cooking step, cooled in a cooling step, and cooked in a second cooking step,
wherein the first cooking step comprises a step selected from the group consisting of baking, par frying, and final frying,
wherein the cooling step comprises a step selected from the group consisting of refrigerating and freezing, and
wherein the second cooking step comprises a step selected from the group consisting of baking, final frying, and reheating.

11. The food product of claim 1, wherein the substrate comprises about 1.0 to about 6.0 wt % corn syrup on a dry ingredient weight basis.

12. The food product of claim 1, wherein an equivalent circular outer diameter of a cross-section of the substrate is about 9-18 mm.

13. The food product of claim 1, wherein an equivalent circular inner diameter of a cross-section of the substrate is about 3-7 mm.

14. The food product of claim 1, wherein a cross-section of the substrate comprises an outer perimeter with a substantially square shape.

15. The food product of claim 1, wherein a cross-sectional area of the filling is a fraction of a cross-sectional area bounded by the substrate, wherein the fraction is about 0.4-0.9.

16. The food product of claim 1, wherein the substrate comprises an emulsifier selected from the group consisting of oil, lecithin, monoglyceride and diglyceride.

17. The food product of claim 1, wherein the substrate comprises a network formed from an alginate and calcium ions.

18. The food product of claim 1, wherein the filling comprises at least one component selected from the group consisting of carboxy methyl cellulose, and an alginate.

19. A method for making a food product, said method comprising the steps of:
coextruding a substrate and a filling to form an extrudate;
cutting the extrudate; and
cooking the extrudate a first time;
wherein the substrate comprises:
at least one component selected from the group consisting of a vegetable, meat, legume, and starch; and
about 30 to about 50 wt % water on a total-substrate-weight basis;
wherein the filling comprises:
about 40 to about 70 wt % water; and
at least one gum; and
wherein a mass ratio of the substrate to the filling is about 90:10 to about 50:50.

20. The method of claim 19, further comprising crimping the extrudate thereby providing a substrate that comprises crimped ends, wherein the step of crimping further comprises completely sealing the filling within the substrate.

21. The method of claim 19, wherein the method further comprises a step of battering the extrudate after said cooking step.

22. The method of claim 21, wherein the method further comprises a step of breading the extrudate after said cooking step.

23. The method of claim 19, wherein the step of cooking the extrudate a first time further comprises par frying the extrudate.

24. The method of claim 19, wherein the method further comprises a step of cooling the extrudate.

25. The method of claim 19, wherein the method further comprises a step of cooking the extrudate a second time.

26. The method of claim 25, wherein the step of cooking the extrudate a second time comprises a step selected from the group consisting of final frying and baking the extrudate.

27. The method of claim 19, wherein the step of cooking the extrudate a first time comprises par frying the extrudate, and wherein the method further comprises steps of freezing the extrudate after par frying the extrudate, and final frying the extrudate after freezing the extrudate.

28. The method of claim 27, wherein the par frying the extrudate comprises par frying for about 30 seconds to 2 minutes at about 200 to about 350° F., wherein the freezing the extrudate comprises reducing the temperature of the extrudate to less than about 10° F., and wherein the final frying the extrudate comprises final frying for about 45 seconds to 2 minutes at about 300 to about 400° F.

29. The method of claim 27, wherein the par frying the extrudate comprises par frying for about one minute at about 250° F., wherein the freezing the extrudate comprises reducing the temperature of the extrudate to less than about 10° F., and wherein the final frying the extrudate comprises final frying for about 1 minute at about 350° F.

30. The method of claim 19, wherein an equivalent circular inner diameter of a nozzle for the substrate is about 9-12.4 mm.

31. The method of claim 19, wherein an equivalent circular outer diameter of a nozzle for the filling is about 6.8-8.6 mm.

32. The method of claim 19, wherein an equivalent circular inner diameter of a nozzle for the filling is about 4.8-6.6 mm.

33. The method of claim 19, wherein a cross-section of a nozzle for the substrate comprises an inner perimeter with a substantially square shape.

34. The method of claim 19, wherein a cross-sectional area bounded by an inner perimeter of a nozzle for the filling is a fraction of the cross-sectional area bounded by an inner perimeter of a nozzle for the substrate, wherein the fraction is about 0.1-0.5.

35. The method of claim 19, wherein a cross-section of a nozzle for the substrate comprises an inner perimeter with a shape that comprises 4 edges with substantially equal lengths, wherein each edge is convex relative to a space bounded by the inner perimeter.

36. The method of claim 19, wherein the filling comprises a non-dissolved, solid inclusion with an equivalent spherical diameter that does not exceed ⅓ of an equivalent circular inner diameter of a cross-section of a nozzle for the filling at any point along the nozzle for the filling.
